(19) United States
(12) Patent Application Publication
(10) Pub. No.: US 2016/0009539 A1
(43) Pub. Date: Jan. 14, 2016

(54) Micro Dosing Dispensing System

(71) Applicant: PEPSICO, INC., Purchase, NY (US)

(72) Inventors: Steven T. Jersey, Laguna Niguel, CA (US); Steven Headen, Purchase, NY (US); Bill Hart, San Jose, CA (US); Celienid Lopez, San Jose, CA (US)

(21) Appl. No.: 14/772,606

(22) PCT Filed: Mar. 13, 2014
(86) PCT No.: PCT/US14/26357

§ 371 Date: Sep. 3, 2015

Related U.S. Application Data
(60) Provisional application No. 61/784,081, filed on Mar. 14, 2013.

(51) Int. Cl. B67D 1/00; F25C 5/00

(52) U.S. Cl. CPC B67D 1/0044; F25C 5/002; B67D 1/0021; B67D 1/004

(57) ABSTRACT

A dispensing nozzle comprises a dispensing nozzle manifold. The manifold comprises orifices. Each orifice comprises a port and a corresponding conduit. The manifold comprises at least a first orifice configured to receive a first diluent, and at least a second diluent orifice configured to receive a second diluent, and at least two free-flowing food component orifices. The dispensing nozzle manifold comprises a top, middle, and bottom portions. The plurality of orifices is located at the top portion. The middle portion comprises a first set of conduits, each conduit of the first set of conduits corresponding to a port. The bottom portion comprises a funnel. The dispensing nozzle is configured so that a diluent received in the funnel mixes with at least one free-flowing food component before the received diluent and the at least one free-flowing food component exit the dispensing nozzle.

### RELATED APPLICATIONS

This application claims priority to U.S. Provisional Application No. 61/784,081 filed on Mar. 14, 2013, the disclosure of which is expressly incorporated herein by reference.

### FIELD OF THE INVENTION

This disclosure relates generally to a method and modular beverage dispensing system for the dispensing of beverages, e.g., for restaurants (including fast food restaurants), cafeterias, theatres, convenience stores, gas stations, and other entertainment and/or food service venues.

### BACKGROUND

Various beverage dispensers, such as those at restaurants, cafeterias, theatres and other entertainment and/or food service venues, typically have either a “drop in” dispenser apparatus or a counter top type dispenser apparatus. In a drop in dispenser apparatus, the dispenser apparatus is self-contained and may be dropped into an aperture of a counter top. In a counter top type dispenser apparatus, the dispenser apparatus is placed on a counter top. In conventional beverage dispensers, a dispensing head is coupled to a particular drink syrup supply source via a single pipe dedicated to supply the particular drink syrup to that dispensing head. Conventional dispensers typically require a dedicated dispensing head for each particular beverage.

A user will typically place a cup under the signage of the selected beverage and either press a button or press the cup against a dispensing lever to activate the dispenser so that the selected beverage is delivered from the dispensing head corresponding to the selected beverage and into the cup until pressure is withdrawn from the button or lever.

Conventional beverage dispensers are typically limited to dispensing a limited number of drinks For example, drinks typically available at a conventional beverage dispenser are a regular cola beverage, a diet cola beverage, perhaps one or several non-cola carbonated beverages, such as a lemon-lime flavored carbonated beverage or some other fruit-flavored drink (e.g., orange flavored carbonated beverage, and/or root beer), and perhaps one more non-carbonated beverage(s), such as a tea and/or a lemonade, with each drink having a separate dispensing nozzle. Conventional beverage dispensers typically have a separate dispensing head or nozzle separate from the separate dispensing nozzles of the flavoring.

Conventional dispensers are not typically configured to permit a user generate or receive from a single dispensing head a custom-ordered beverage that a consumer may wish to purchase, e.g., a cola flavored with cherry, vanilla, lemon, or lime, etc., or a tea flavored with lemon, orange, peach, raspberry, etc., or a tea having one or more teaspoons of sweetener (sugar, or some other nutritive sweetener or non-nutritive sweetener).

What is needed is a beverage dispensing system that does not have the limitations and disadvantages of conventional beverage dispensers and methods.

### SUMMARY

In one aspect, a dispensing nozzle is provided. The dispensing nozzle comprises a top portion, a middle portion, and a bottom portion. The dispensing nozzle comprises a dispensing nozzle manifold. The dispensing nozzle manifold comprises a plurality of orifices. Each orifice comprises a corresponding port and a corresponding conduit. The dispensing nozzle manifold comprises at least a first orifice configured to receive a first diluent, and at least a second diluent orifice configured to receive a second diluent, and at least two free-flowing food component orifices. The top portion of the dispensing nozzle comprises a plurality of ports, each port corresponding to an orifice of the plurality of orifices. The middle portion of the dispensing nozzle manifold comprises a first set of conduits, each conduit of the first set of conduits corresponding to a port. The bottom portion of the dispensing nozzle comprises a funnel having a side wall. The funnel is configured is configured to receive at least the first diluent and/or at least the second diluent, and allow the received diluent to flow downwardly and in a swirling path along the side wall of the funnel and mix with at least one free-flowing food component before the received diluent and the at least one free-flowing food component exit the dispensing nozzle.

The above and other aspects, features and advantages of the present disclosure will be apparent from the following detailed description of the illustrated embodiments thereof which are to be read in connection with the accompanying drawings.

### BRIEF DESCRIPTION OF THE DRAWINGS

FIG. 1 is a perspective view of an embodiment of a standalone dispensing system according to various aspects of the disclosure.

FIG. 2 is a perspective view of an embodiment of a dispensing system for a countertop according to various aspects of the disclosure.

FIG. 3 is a perspective view of an embodiment of a dispensing system for a countertop according to various aspects of the disclosure.

FIG. 4 is a front view of an embodiment of a dispensing system to various aspects of the disclosure.

FIG. 5 is a side view of the embodiment shown in FIG. 4, taken along line 5-5 in FIG. 4.

FIG. 6 is a perspective view of a central ingredient system according to various aspects of the disclosure.

FIG. 7 is a rear view of a central ingredient rack system according to various aspects of the disclosure.

FIG. 8 is a rear view of central ingredient system according to various aspects of the disclosure.

FIG. 9 is a side view of the embodiment shown in FIG. 8, taken along line 9-9 in FIG. 8.

FIG. 10A is a perspective view of a rack for a central ingredient system according to various aspects of the disclosure.

FIG. 10B is a top plan view of a shelf shown in FIG. 10A.

FIG. 10C is a rear view of a shelf shown in FIG. 10A.

FIG. 11 is a side view of an embodiment of a pump assembly according to various aspects of the disclosure.

FIG. 12 is a perspective view of an embodiment of a six pump assembly according to various aspects of the disclosure.

FIG. 13 is a side view of an embodiment of a manifold assembly according to various aspects of the disclosure.

FIG. 14 is a view of the embodiment shown in FIG. 13, taken along line 14-14 in FIG. 13 according to various aspects of the disclosure.

FIG. 15 is a rear perspective view the embodiment shown in FIG. 13 according to various aspects of the disclosure.

FIG. 16 is a perspective view of an embodiment according to various aspects of the disclosure.

FIG. 17 is a top plan view of the embodiment shown in FIG. 16 according to various aspects of the disclosure.

FIG. 18 is a cross sectional side view of the embodiment shown in FIG. 17 taken along line 18-18 in FIG. 17 according to various aspects of the disclosure.

FIG. 19 is a bottom view of an embodiment according to various aspects of the disclosure.

FIG. 20 is an isometric view of an embodiment according to various aspects of the disclosure.

FIG. 21 is a perspective view of an embodiment according to various aspects of the disclosure.

FIG. 22 is perspective view of an embodiment according to various aspects of the disclosure.

FIG. 23 is a perspective view of an embodiment according to various aspects of the disclosure.

FIG. 24 is a perspective view of an embodiment according to various aspects of the disclosure.

FIG. 25 is a bottom perspective view of an embodiment according to various aspects of the disclosure.

FIG. 26 is a side view of an embodiment of a funnel according to various aspects of the disclosure.

FIG. 27 is a top perspective view of a manifold according to various aspects of the disclosure.

FIG. 28 is a top partial view of the manifold shown in FIG. 27.

FIG. 29 illustrates a cutaway view of an embodiment according to various aspects of the disclosure.

FIG. 30 illustrates a cutaway view of an embodiment according to various aspects of the disclosure.

FIG. 31 illustrates a perspective view of an embodiment according to various aspects of the disclosure.

FIG. 32 illustrates a profile of an embodiment in accordance with aspects of the disclosure.

FIG. 33 illustrates flow of fluid from an embodiment in accordance with aspects of the disclosure.

FIG. 34 illustrates a perspective view of an embodiment according to various aspects of the disclosure.

FIG. 35 illustrates a profile of an embodiment in accordance with aspects of the disclosure.

FIG. 36 illustrates flow of fluid from an embodiment in accordance with aspects of the disclosure.

FIG. 37 illustrates a perspective view of an embodiment according to various aspects of the disclosure.

FIG. 38 illustrates a profile of an embodiment in accordance with aspects of the disclosure.

FIG. 39 illustrates flow of fluid from an embodiment in accordance with aspects of the disclosure.

FIG. 40 is a cutaway view of an embodiment in accordance with aspects of the disclosure.

FIG. 41 is a top perspective view of an embodiment in accordance with aspects of the disclosure.

FIG. 42 is a top perspective view of a body 4200 according to various aspects of the disclosure.

FIG. 43 is a bottom view of a light ring of a dispensing system according to various aspects of the disclosure.

### DETAILED DESCRIPTION

The embodiments discussed below may be used to form a wide variety of beverages, including but not limited to cold and hot beverages, and including but not limited to beverages known under any PepsiCo branded name, such as Pepsi-Cola®.

In one aspect, a dispensing nozzle is provided. The dispensing nozzle comprises a dispensing nozzle manifold. The dispensing nozzle manifold comprises a plurality of orifices. Each orifice comprises a port and a corresponding conduit. The nozzle manifold comprises at least a first orifice configured to receive a first diluent, and at least a second diluent orifice configured to receive a second diluent, and at least two free-flowing food component orifices. The dispensing nozzle comprises a top portion, a middle portion, and a bottom portion. The plurality of ports is located at the top portion of the dispensing nozzle. The middle portion of the dispensing nozzle comprises a first set of conduits, each conduit of the first set of conduits corresponding to a port. The bottom portion of the dispensing nozzle comprises a funnel. The funnel comprises a side wall and is configured to receive at least the first diluent. The received diluent flows downwardly and in a swirling path along the side wall of the funnel. The dispensing nozzle is configured so that as the received diluent is directed downwardly and in a swirling path along the side wall of the funnel, the received diluent mixes with at least one free-flowing food component before the received diluent and the at least one free-flowing food component exit the dispensing nozzle.

According to aspects of the disclosure, the dispensing nozzle comprises at least a first diluent port configured to receive a first diluent, and at least a second diluent port configured to receive a second diluent, a medium dose port configured to receive a medium dose of a first free-flowing food component, and at least two small dose ports wherein at least a first small dose port is configured to receive a small dose of a second free-flowing food component, and wherein at least a second small dose port is configured to receive a small dose of a third free-flowing food component. The dispensing nozzle comprises a top portion, a middle portion, and a bottom portion. The plurality of ports is located at the top portion of the dispensing nozzle. The middle portion of the dispensing nozzle comprises a first set of conduits, each conduit of the first set of conduits corresponding to a medium dose port. The middle portion of the dispensing nozzle manifold comprises a second set of conduits, each conduit of the second set of conduits corresponding to a small dose port. The bottom portion of the dispensing nozzle comprises a funnel. The funnel comprises a side wall and is configured to receive at least the first diluent and/or the second diluent. The received diluent flows downwardly and is angled in a swirling path along the side wall of the funnel. The dispensing nozzle is configured so that as the received diluent is angled downwardly and in a swirling path along the side wall of the funnel, the received diluent mixes with at least one free-flowing food component before the received diluent and the at least one free-flowing food component exit the dispensing nozzle.

In accordance with aspects of the disclosure, a port and corresponding conduit may correspond to a flavor component for a free flowing food product, e.g., a beverage. The flavor component may comprise a syrup. The flavor component may be a micro component for a free flowing food product.

In accordance with aspects of the disclosure, a flavor component may be injected through a port without contact with a diluent, such as water, a dairy-based liquid, and/or a juice. In accordance with aspects of the disclosure, when a flavor component flows through a port and out of a corresponding conduit, and the injection of the flavor component into the port is stopped, there is a “suck back” effect wherein an amount of flavor component that has exited the conduit snaps back into the conduit and stays within the conduit due to the capillary effect. Those skilled in the art will recognize that, in accordance with aspects of the disclosure, an orifice may be configured so that the port and the conduit have a predetermined diameter and/or a predetermined length. Those skilled in the art will recognize that in accordance with aspects of the disclosure, an orifice may be configured to provide a flow path wherein a component having a particular elasticity squeezes through and out the conduit the bottom of the conduit at a particular velocity. When dispensing is to be completed, flow to the orifice is closed off, but component in the orifice continues to move within the orifice until it reaches a sufficient resistance that is in the orifice until it stops, and the tail end of the component continues to flow, thereby stretching and narrowing itself out until it snaps. A first portion of the component that has exited the bottom of the conduit snaps off from a second portion of the component that has exited the bottom of the conduit, and the first portion of the component is sucked back up into the conduit and is maintained within the conduit. The snap or break between the first portion and the second portion of the component occurs below the bottom of the dispensing nozzle manifold. This configuration helps reduce or eliminate undesirable carryover of component in the dispensing of a subsequent free flowing food product from the dispensing nozzle. For example, the configuration allows for the dispensing of a dark beverage, e.g., a cola, from the dispensing nozzle, and later, the dispensing of a light or non-colored beverage, e.g., a lemon-lime beverage, from the same dispensing nozzle without dark spots or cola flavors or odors in the light or non-colored beverage dispensed from the dispensing nozzle. Those skilled in the art will recognize that, in accordance with aspect of the disclosure, a dispensing nozzle may be configured to provide these features. Flow of a component to an orifice may be stopped by closing off a valve that is upstream of the orifice, such as a valve located between a component source and the orifice.

Those skilled in the art will recognize that in accordance with aspects of the disclosure, a port and conduit may be configured depending on the viscosity of the ingredient or component to flow through the port and conduit. Thus, a first port and corresponding conduit may have a different size than a second port and corresponding conduit.

Those skilled in the art will recognize that in accordance with aspects of the disclosure, an ingredient or component may be dispensed through multiple orifices. For example, but not by way of limitation, high fructose corn syrup (HFCS) may be dispensed through more than one orifice.

In accordance with aspects of the disclosure, an ingredient or component may be dispensed from an orifice at vertically downward, i.e., downward at about 90 degrees to horizontal. Those skilled in the art will recognize that a component may be dispensed straight down through a conduit and into a diluent curtain, such as a water curtain. The water curtain may comprise carbonated or non-carbonated water. The port and the conduit may be configured so that gravity shoots a component straight down through the conduit of the orifice. In accordance with aspects of the disclosure, the diluent curtain is angled downward. The component, such as a flavor component, may be shot or dropped straight down from the conduit into the angled diluent curtain.

A dispensing nozzle manifold may comprise diluent ports, sweetener ports, medium dose ports, and small dose ports. Each sweetener port, medium dose port, and small dose port may have a corresponding conduit. A sweetener port may receive a sweetener, e.g., HFCS. A medium dose port may receive a tea component (e.g., a black tea or a green tea component). A medium dose port may receive a nonnutritive sweetener.

In accordance with aspects of the disclosure, a dispensing nozzle may comprise a dispensing nozzle manifold comprising four sweetener orifices configured for receiving four streams of a sweetener, e.g. HFCS. The dispensing nozzle manifold may comprise two orifices configured to receive two streams of a non-nutritive sweetener, e.g., aspartame. Those skilled in the art will recognize that, in accordance with aspects of the disclosure, a diluent curtain, e.g., a water curtain may be provided that coats an inside surface of a nozzle cone or funnel, and that other components of a beverage are dropped down into the diluent curtain. In an embodiment, the nozzle cone or funnel may taper down to an opening at the bottom of the funnel having a diameter of about 1 inch to about 2 inches. In an embodiment, the nozzle funnel has an opening at the bottom of about 1.5 inches. In another embodiment, the nozzle funnel has an opening at the bottom of about 2 inches. The opening at the bottom of the funnel may be large enough for ice cubes to exit the bottom of the funnel. A typical ice cube has a side length of about one inch.

Those skilled in the art will recognize that, in accordance with aspect of the disclosure, the dispensing nozzle may provide a laminar flow of a diluent within the nozzle and that another component(s) may be dropped into the diluent and becomes part of the laminar flow of effluent coming out of the dispensing nozzle. The total flow from a dispensing nozzle in accordance with aspects of the disclosure may be between about 3 to 4 ounces per second. In accordance with aspects of the disclosure, a diluent, e.g., water, may flow through a dispensing nozzle for a first period of time, e.g. up to about 200 milliseconds, and into a cup. After the first period of time, the diluent may continue to flow through the dispensing nozzle for a second period of time. During the second period of time, other components of a free flowing food product may be dropped from conduits of the manifold and into the diluent curtain in the funnel of the nozzle. These other components, e.g., nutritive sweetener(s), nonnutritive sweetener(s), acid (e.g., citric or phosphoric acid), and flavor(s), may be dropped from respective conduits during for part of the second period of time. For example, flavor “shots” of about 200 to about 800 milliseconds may be dropped from conduit(s) of the manifold during the second period of time. After the end of the second period of time, the diluent may continue to flow through the dispensing nozzle for a third period of time to wash down any residual of other components from the interior surface of the nozzle funnel and into the cup. For example, a free flowing food product may be dispensed from a nozzle and into a cup placed below the nozzle as follows: (i) for about the first 200 milliseconds, a diluent is dispensed from the nozzle; (ii) for about the next 600 milliseconds a mixture of diluent and other components of the free flowing food product is dispensed form the nozzle; and (iii) for about the next 200 milliseconds, the diluent is dispensed from the nozzle. Thus, in an embodiment, the nozzle dispenses diluent from the nozzle for about the first fifth of a dispensing cycle, then a mixture of diluent and other components are dispensed from the nozzle for the next three fifths of a dispensing cycle, and the nozzle dispenses the diluent from the nozzle for about the last fifth of a dispensing cycle. A dispensing cycle may comprise a dispensing of twelve ounces that in total comprises a free flowing food product, e.g., into a cup placed underneath the dispensing nozzle. In an embodiment, a twelve once beverage, e.g., a cola, is dispensed from the dispensing nozzle in about 0.5 seconds.

The nozzle may be configured to dispense ice. The nozzle may be configured to dispense ice down a middle pathway of the nozzle. The middle pathway of the nozzle may be surrounded by the plurality of orifices for non-ice components of free flowing food product(s). A single nozzle may thus be configured to dispense an entire, finished free flowing food product, such as a finished beverage, including ice. The middle pathway of the nozzle extends from a top opening at the top portion of the dispensing nozzle manifold to the middle portion of the dispensing nozzle manifold, and ice will then drop from a bottom opening at the bottom of the middle pathway and into the funnel of nozzle.

In accordance with aspects of the disclosure, an ice bin or hopper may be configured to provide ice to the top opening of the middle pathway. An ice transport tube may be provided at an outlet of the ice hopper. The ice transport tube may be configured to receive ice from the ice hopper. The ice transport tube may comprise an ice funnel at an outlet of the ice transport tube. An air gap may be provided between the outlet of the ice transport tube and the top opening of the middle pathway. The air gap may be in an ice funnel of an ice chute. The air gap may be configured to reduce or prevent material from going back up through the ice transport tube and into the hopper. Thus, the air gap may be configured to reduce or prevent contamination of the ice hopper. The air gap may be configured so that if there is some splashing up of material from the dispensing nozzle manifold, the material would enter the air gap, and then exit the air gap along the sides of the ice funnel and drops back down the middle pathway.

The ice hopper may comprise a door that has an open position to dispense ice when desired, and a closed position to keep ice from exiting the ice hopper. The door may have a guillotine-type configuration, wherein it slides up to the open position and slides down to the closed position.

The ice transport tube may be configured to have a bend so that ice is initially angled from a slight angle downwardly from the ice hopper, and then angled further as it travels through the ice transport tube, and is then dropped straight vertically down by the time the ice reaches an outlet of the ice transport tube. The ice transport tube may be off a side of and towards the bottom of the ice hopper. The ice transport tube may be about 18 to 20 inches long. The ice hopper may have an auger inside the ice hopper to reduce or prevent the ice in the ice hopper from clumping. The auger may be at or near the bottom of the ice hopper. A moving arm or slinger in the ice hopper may be provided to move around within the ice hopper to push ice from the ice hopper to the ice transport tube.

In an embodiment, the middle pathway has a diameter of about 1 inch to about 2 inches.

In an embodiment, the middle pathway has an opening at its bottom of about 1.5 inches. In another embodiment, the middle pathway has an opening at its bottom of about 2 inches. The opening at the bottom of the middle pathway is large enough for ice cubes to exit the bottom of the middle pathway.

The nozzle funnel may comprise an ice gate. The ice gate may be configured to allow ice to fall through the ice gate due to the weight of the ice after a sufficient amount of ice is allowed to move through the middle pathway to the ice gate. The ice gate may be configured so that when no ice is pushing through the ice gate, the ice gate closes to form an opening having a smaller diameter than when ice is pushing through the ice gate. The ice gate may be configured to reduce or prevent material from going back up through the ice chute and into the hopper. Thus, the ice gate may be configured to reduce or prevent contamination of the ice hopper. The ice gate may comprise flaps that flare open to a first diameter when a sufficient amount of ice is pushing on the flaps and that narrow to a second diameter when an insufficient amount of ice is pushing on the flaps, wherein the second diameter is smaller than the first diameter. The second diameter may be configured to be large enough to allow free flowing food product components to exit through second diameter.

In accordance with aspects of the disclosure, a dispensing system comprising the dispensing nozzle may be provided. The dispensing system may be configured to dispense a free flowing food product. The free flowing food product may be dispensed when a container or cup is placed underneath the dispensing nozzle, such as onto a platform. A user may initiate the dispensing of the free flowing food product, e.g., by pushing or using a touchscreen to make a selection of the free flowing food product to be dispensed by the dispensing system.

In an embodiment, ice for the free flowing food product is dispensed by the dispensing system into the cup. Following the dispensing of the ice by the dispensing system into the cup, the non-ice components of the free flowing food product are dispensed by the dispensing system into the cup. In another embodiment, non-ice components are dispensing during at least a portion of the time that the ice is dispensed into the cup. Either of these embodiments may be used at a dispensing system wherein a user is a consumer, e.g., at a self-serve station, or may be used at a crew or server station, wherein a user is a server who will be delivering the finished free flowing food product to a counter, delivery area or consumer.

In a crew or server station application, the following steps may be provided. A consumer may place an order for a beverage at an ordering station, e.g., a drive through intercom or window. A crew or server member can then press a button or use a touchscreen to communicate the order to the dispensing system. The dispensing system is configured to dispense the ordered beverage into a cup that has been placed under the dispensing nozzle of the system.

The dispensing system may be configured to dispense different amounts of ice depending on the order. For example, a button or touchscreen icon may be provided for a standard amount of ice for the ordered beverage, and another button(s) or touchscreen icon(s) may be provided if a beverage is ordered with a lower or higher amount of ice. In an embodiment, buttons or touchscreen icons corresponding to low, medium, and high amount of ice may be provided. The medium amount of ice may correspond to the standard amount of ice for an ordered beverage.

In accordance with aspects of the disclosure, the delivery of ice into a cup by the dispensing nozzle facilitates a cradling of the beverage as it is dropping from the nozzle, thereby reducing or preventing splashing of the beverage as it goes into the cup.

In accordance with aspects of the disclosure, the dispensing system may comprise a plurality of cartridges and corresponding pumps. Each cartridge may have a corresponding pump. The number of pumps may be any desirable number. The cartridges and corresponding pumps may be grouped in sets or packs. There may be a six pack of cartridges and corresponding pumps on each shelf of a cartridge rack. In accordance with aspects of the disclosure, the dispensing system may have five rows. Each row may comprise a six pack of cartridges and corresponding pumps. Each row may be placed on a shelf of a cartridge rack of the dispensing system. In an embodiment, some cartridges may be grouped as singles and/or pairs. A double cartridge may provide the same amount of a food product component as two single cartridges. Those skilled in the art will recognize that, in accordance with aspects of the disclosure, any suitable number of cartridges may be provided in a dispensing system. Those skilled in the art will recognize that, in accordance with aspects of the disclosure, one or more cartridges may comprise a micro component for a free flowing food product. In accordance with aspects of the disclosure, micro components may have a concentration to a diluent, such as water from about 80-100:1. In accordance with aspects of the disclosure, a micro component may have a concentration to a diluent of greater than 100:1. In accordance with an aspect of the disclosure, a “flavor” shot, e.g., a grape flavor shot may be about 200:1. In accordance with aspects of the disclosure, a lemonade acidulant concentration may be about 100:1. In accordance with aspects of the disclosure, the micro component may comprise concentrations as follows: tea acidulant/solids is about 40:1+ Tea Flavor is about 200:1).

A cartridge may be configured to have an exterior profile that corresponds to a guide of the shelf or row of the dispensing system. Thus, the cartridge may be moved onto a shelf or row of the dispensing system if the exterior profile matches the guide. By having a certain exterior profile, the cartridge cannot be loaded incorrectly, e.g. backwards, or in the wrong location on the shelf or row of the dispensing system. For example, the cartridge may have a first end having a bottom surface that corresponds to a guide of the shelf or row of a dispensing system, and a second end having a bottom surface that does not correspond to the guide. Thus, the cartridge may only be inserted into the dispensing system by inserting the first end of the cartridge so that it moves along the guide as the cartridge is inserted. Since the second end of the cartridge does not correspond to the guide, an attempt to insert the cartridge by inserting the second end of the cartridge is prevented due to the second end abutting against the guide.

In accordance with aspects of the disclosure, a cartridge may comprise a radio frequency identification (“RFID”) tag. The RFID tag may be configured to identify whether the cartridge has been used previously, the amount of a component that is stored in the cartridge, the component in the cartridge, and/or the whether the cartridge is being loaded into the correct slot. The RFID tag may be configured to activate a light when the cartridge is placed near or at a slot of a shelf of the dispensing system. The dispensing system may be configured to activate a door and/or a release mechanism when a cartridge becomes empty or sufficiently emptied. An RFID tag may be configured to activate the door and/or release mechanism.

In accordance with aspects of the disclosure, one pump pack may be configured to feed component(s) to a plurality of dispensing nozzles. The dispensing nozzles may be located at one or more countertops. A central ingredient system may comprise one or more pump packs. The central ingredient system (“CIS”) may sit under a counter having one or more dispensing nozzles.

In accordance with aspects of the disclosure, a shelf or rack of the dispensing system may comprise a drip-leak capture and containment tray or vessel. The tray or vessel may be configured to collect drips or leaks that come from a cartridge or a connection between the cartridge and a line between the cartridge and the dispensing nozzle. A funnel may be provided to funnel drips and leaks to the containment vessel. The containment vessel may comprise a float and an alarm. When the float is activated, such as when the containment vessel receives a predetermined amount of drips and/or leaks, the alarm may be activated. The dispensing system may be configured so that when the float is activated, the dispensing system shuts down and goes into a non-dispensing mode. The dispensing system may be configured to transmit a signal, the signal corresponding to a request for service, such as a request to repair the drip and/or leak. The dispensing system may comprise a secondary containment vessel. The secondary containment vessel may catch any material that overflows from a primary containment vessel. The primary containment vessel may hold about the same amount of material as a cartridge, e.g., about 20 ounces of fluid. Thus, if a cartridge catastrophically fails and leaks material, the primary containment vessel will be large enough to hold that material, and any additional drip or leakage from some other cartridge will cause the primary containment vessel to overflow to the secondary containment vessel. In a configuration with a secondary containment vessel, the primary containment vessel will comprise the float. The primary containment vessel may be smaller than the secondary container vessel. The primary containment vessel may sit inside a slot well, and any overflow from the primary containment vessel may be contained in the secondary containment vessel. The primary containment vessel may be located below the bottom shelf of the cartridge shelves, e.g., about six inches below the bottom shelf.

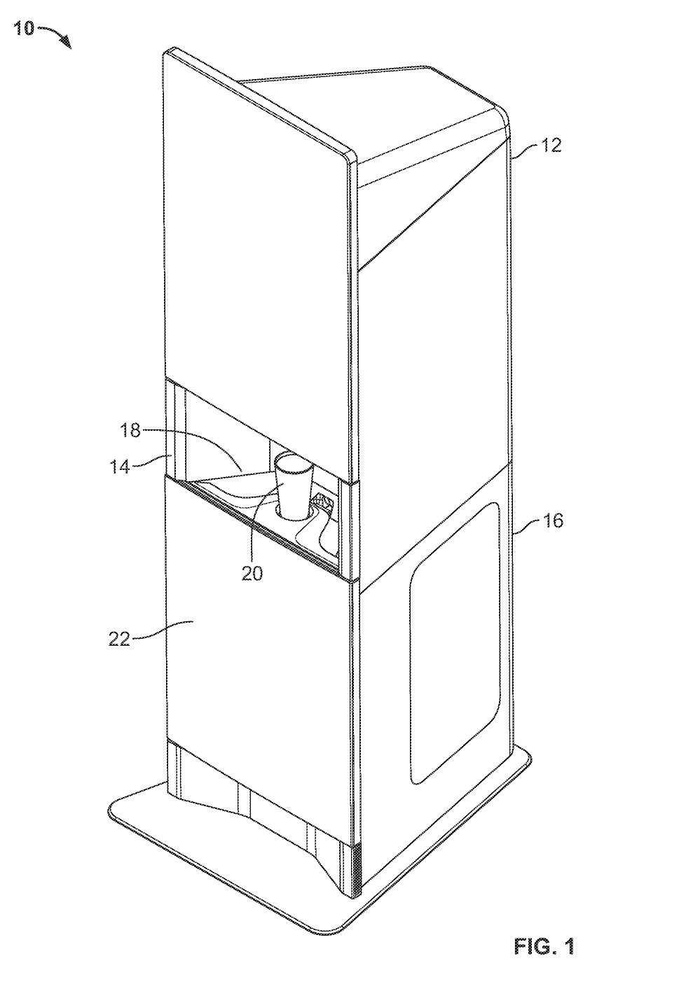

FIG. 1 is a perspective view of an embodiment of a standalone dispensing system 10 according to various aspects of the disclosure. System 10 may be configured to receive water from a water source remote from system 10, e.g., a water source in a backroom. System 10 comprises an upper portion 12, a middle portion 14, and a lower portion 16. Upper portion 12 may comprise an ice maker and ice hopper, and a dispensing nozzle and dispensing nozzle manifold. Middle portion 14 may comprise an enclave 18 configured to receive a cup 20 underneath the dispensing nozzle of the upper portion 12. Lower portion 16 may comprise a central ingredient system. The inside of lower portion 16 may be accessed by opening door 22.

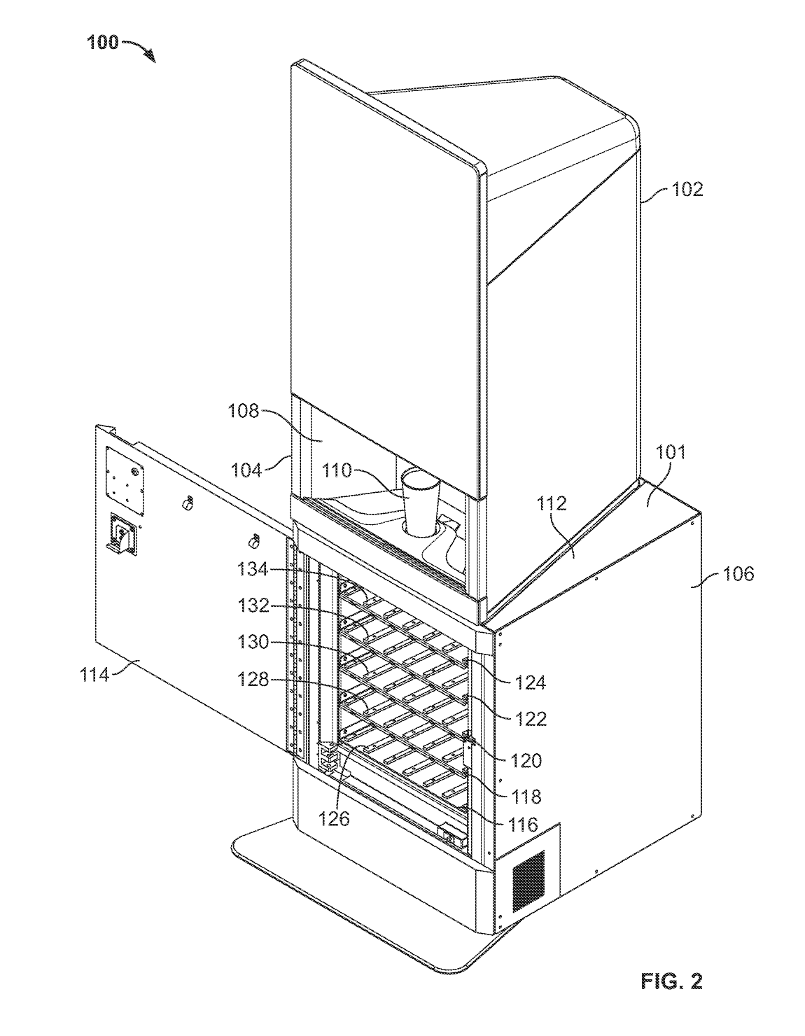

FIG. 2 is a perspective view of an embodiment of a dispensing system 100 for a countertop 101 according to various aspects of the disclosure. System 100 may be similar to system 10 in FIG. 1, with the exception that system 100 is configured for a countertop 101. System 100 may be configured to receive water from a water source remote from system 100, e.g., a water source in a backroom. System 100 comprises an upper portion 102, a middle portion 104, and a lower portion 106. Upper portion 102 may comprise an ice maker and ice hopper, and a dispensing nozzle and dispensing nozzle manifold. Middle portion 104 may comprise an enclave 108 configured to receive a cup 110 underneath the dispensing nozzle of the upper portion 102. Lower portion 106 may comprise a central ingredient system. Lower portion 106 may have a top surface 112 that is a part of countertop 101 or which has the same height as countertop 101. Lower portion 106 may comprise a door 114 that may be opened to load components for a free flowing food product onto shelves 116, 118, 120, 122, and 124 of the central ingredient system. Shelves 116, 118, 120, 122, and 124 may comprise guides 126, 128, 130, 132, and 134, respectively.

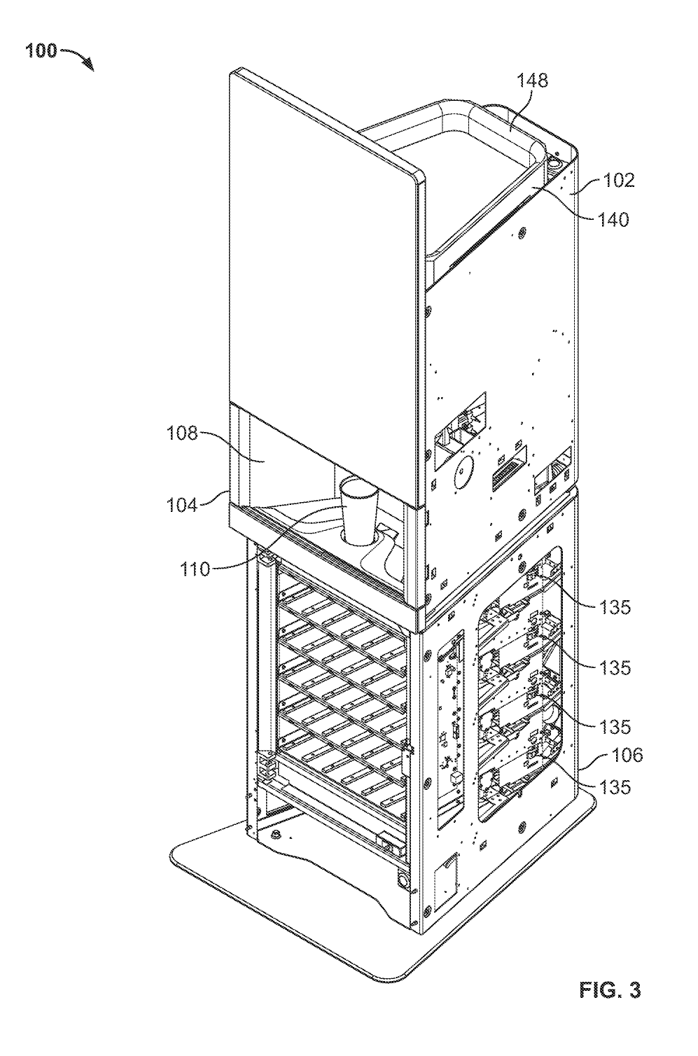

FIG. 3 is a perspective view of an embodiment of a dispensing system for a countertop according to various aspects of the disclosure. FIG. 3 illustrates dispensing system 100 of FIG. 2, without door 114 being shown. FIG. 3 shows cut-away portions. Pump assemblies 135 are provided, with each pump assembly 135 corresponding to a cartridge that is placed on a shelf of the central ingredient system. In FIG. 3, only four pump assemblies 135 are shown. Dispensing system 100 comprises an ice hopper 140 in upper portion 102. Ice hopper 140 comprises a lid 148.

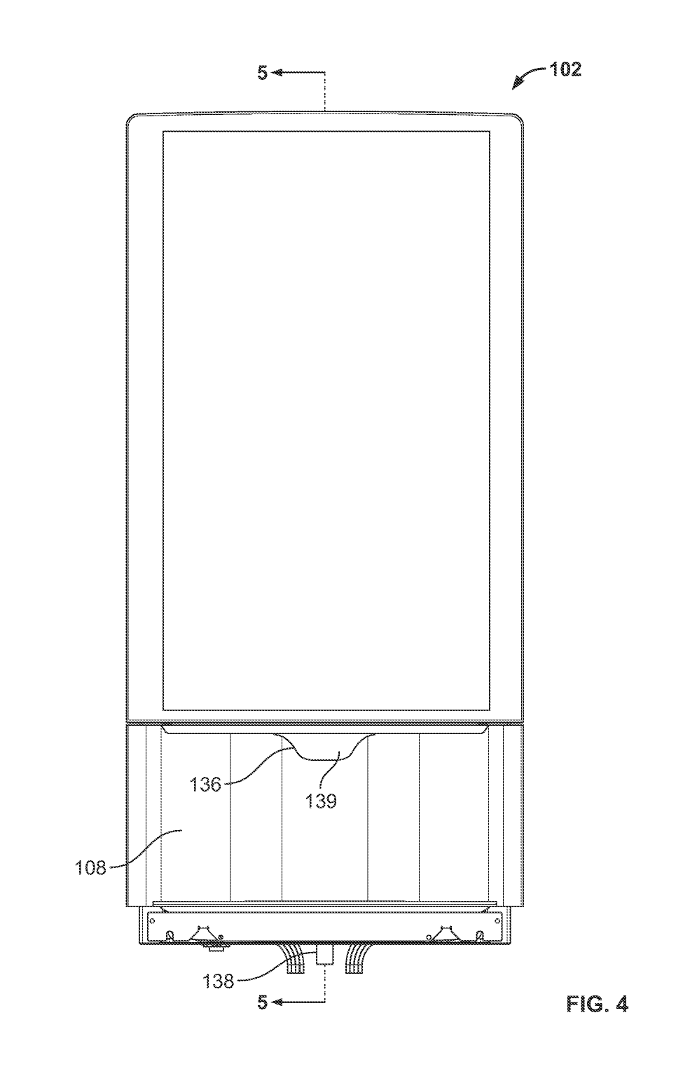

FIG. 4 is a front view of the upper portion 102 of the dispensing system shown in FIG. 2 according to various aspects of the disclosure. FIG. 4 shows the bottom of a dispensing nozzle 136. As shown in FIG. 4, a drain 138 is provided at the bottom of upper portion 108. Drain 138 is provided to allow any liquid that falls or otherwise collects at the bottom of enclave 108 can be drained away.

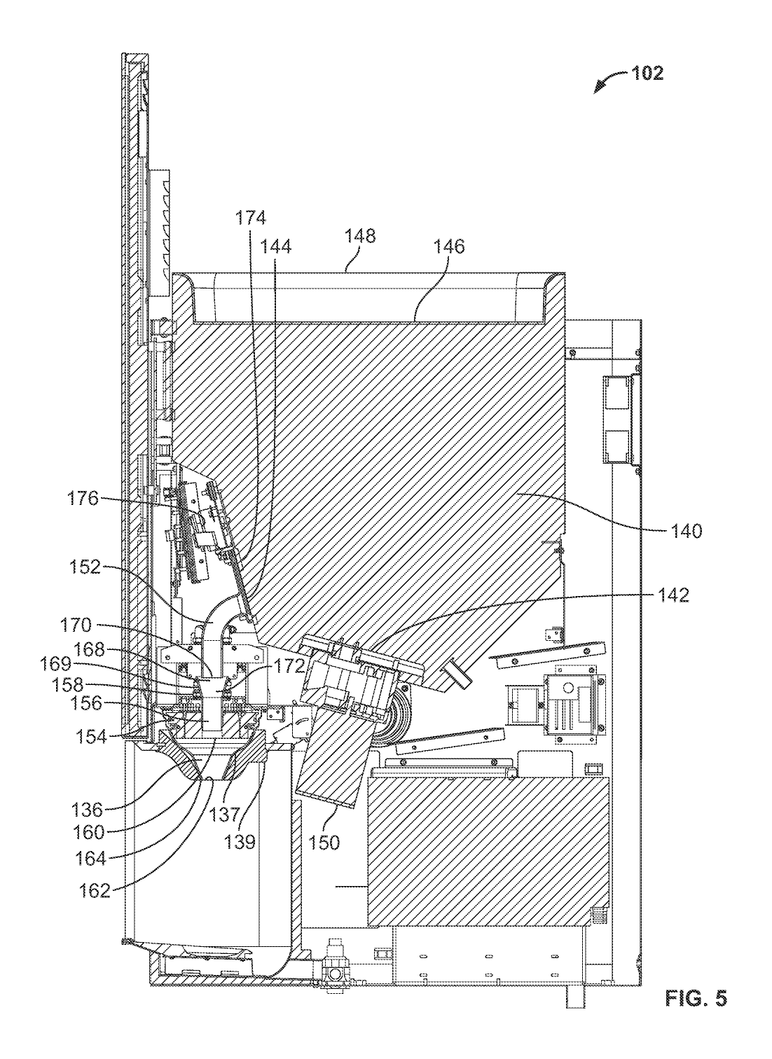

FIG. 5 is a side view of the embodiment shown in FIG. 4, taken along line 5-5 in FIG. 4. As previously noted, upper portion 102 comprises ice hopper 140. Ice hopper 140 comprises an auger 142 to prevent ice from clumping and to move ice towards outlet 144. Ice hopper 140 is configured to receive ice at its top 146 after removing lid 148. In an alternative embodiment, the upper portion comprises an ice maker that supplies ice to ice hopper 140. A motor 150 is configured to activate and cause the auger to move in a manner that acts to prevent ice from clumping and to move ice towards outlet 144. An ice transport tube 152 is configured to receive ice from outlet 144. Ice transport tube 152 may comprise an elbow-shaped tube. As shown in FIG. 5, dispensing nozzle 136 comprises a body 137, an outer shell 139, and a dispensing nozzle manifold 154. Ice hopper 140 is configured to provide ice to a dispensing nozzle manifold 154 of nozzle 136. Manifold 154 may comprise a middle pathway 156. Middle pathway 156 comprises a top opening 158, and a bottom opening 160. A dispensing nozzle 136 comprises a dispensing opening 162. Dispensing nozzle 136 comprises a funnel 164.

Ice transport tube 152 comprises an ice funnel 168 at opening 170. An air gap 172 may be provided between opening 170 and top opening 158 of the middle pathway 156. Air gap 172 may be in ice funnel 168 of ice chute 169. Air gap 172 may be configured to reduce or prevent material from going back up through ice transport tube 152 and into ice hopper 140. Thus, air gap 172 may be configured to reduce or prevent contamination of ice hopper 140. Air gap 172 may be configured so that if there is some splashing up of material from dispensing nozzle manifold 154, the material would enter air gap 172, and then exit air gap 172 along the sides of the ice funnel 168 and drop back down middle pathway 156.

Ice hopper 140 may comprise a door 174 that has an open position to dispense ice when desired, and a closed position to keep ice from exiting ice hopper 140. Door 174 may have a guillotine-type configuration, wherein it slides up to the open position and slides down to the closed position. A sliding arm 176 can be attached to door 174 and control movement of door 174 as desired.

Ice transport tube 152 may be configured to have a bend so that ice is initially angled from a slight angle downwardly from ice hopper 140, and then angled further as it travels through ice transport tube 152, and is then dropped straight vertically down by the time the ice reaches outlet 170. Ice transport tube 152 may be off a side and towards the bottom of ice hopper 140. Ice transport tube 152 may be about 18 to 20 inches long. Ice hopper 140 may have an auger inside the ice hopper to reduce or prevent the ice in the ice hopper from clumping. The auger may be at or near the bottom of the ice hopper. A moving arm or slinger in the ice hopper may be provided to move around within the ice hopper to push ice from the ice hopper to ice transport tube 152. In accordance with aspects of the disclosure, the auger may comprise the arm or slinger. In accordance with aspects of the disclosure, the auger may comprise one or more apertures to sling ice toward the gate.

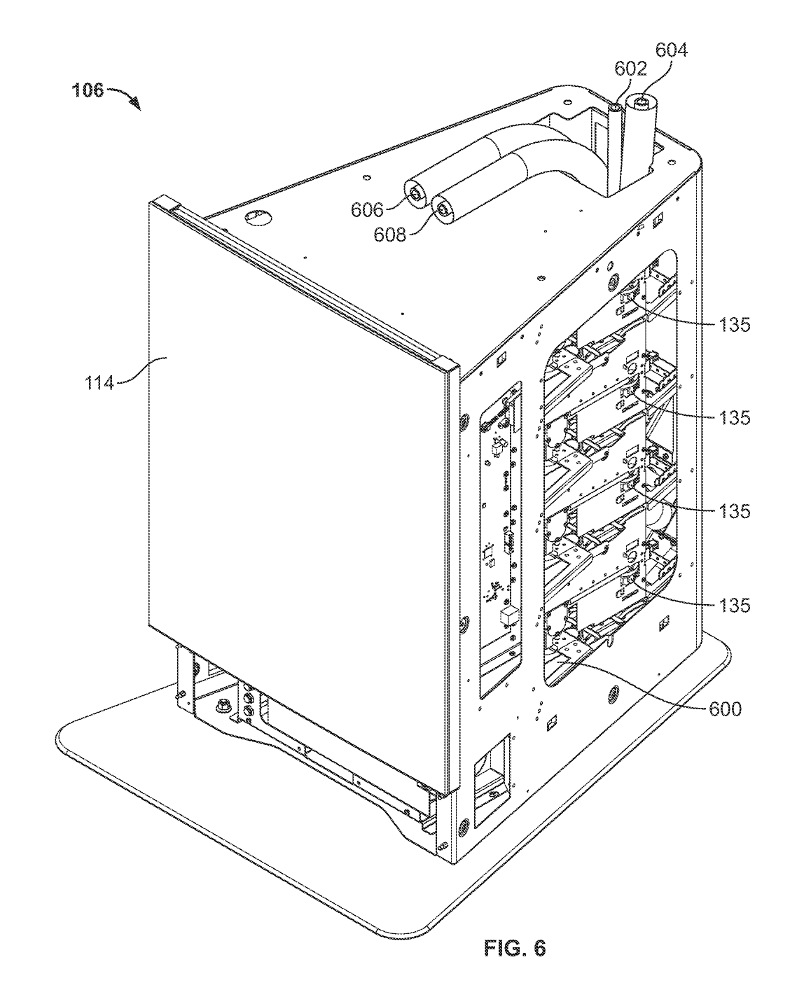

FIG. 6 is a perspective view of a central ingredient system according to various aspects of the disclosure. Specifically, central ingredient system 600 is within lower portion 106. Central ingredient system 600 comprises cartridges on shelves 116, 118, 120, 122, and 124, as shown in FIG. 2. Central ingredient system may comprise five rows of six pack pump assemblies 135, with each row corresponding to shelves 116, 118, 120, 122, and 124 as shown in FIG. 2, respectively. In FIG. 6, only four pump assemblies 135 are shown. Central ingredient system 600 comprises a plurality of feeding tubes 602 and 604. Those skilled in the art will recognize that, in accordance with aspects of the disclosure, any number of feeding tubes may correspond to components to be fed from cartridges to the dispensing nozzle manifold. Lower portion 106 may be configured to comprise drain tubes 606 and 608. Drain tube 606 may correspond to a drain of the ice hopper 140, and thus drain any liquid in the ice hopper. Drain tube 608 may correspond to drain 402, and thus drain any material that drops through drain 402. Drain tubes 606 and 608 may be configured to drain liquid out towards the back of lower portion 106 to a further drain, such as a wastewater drain.

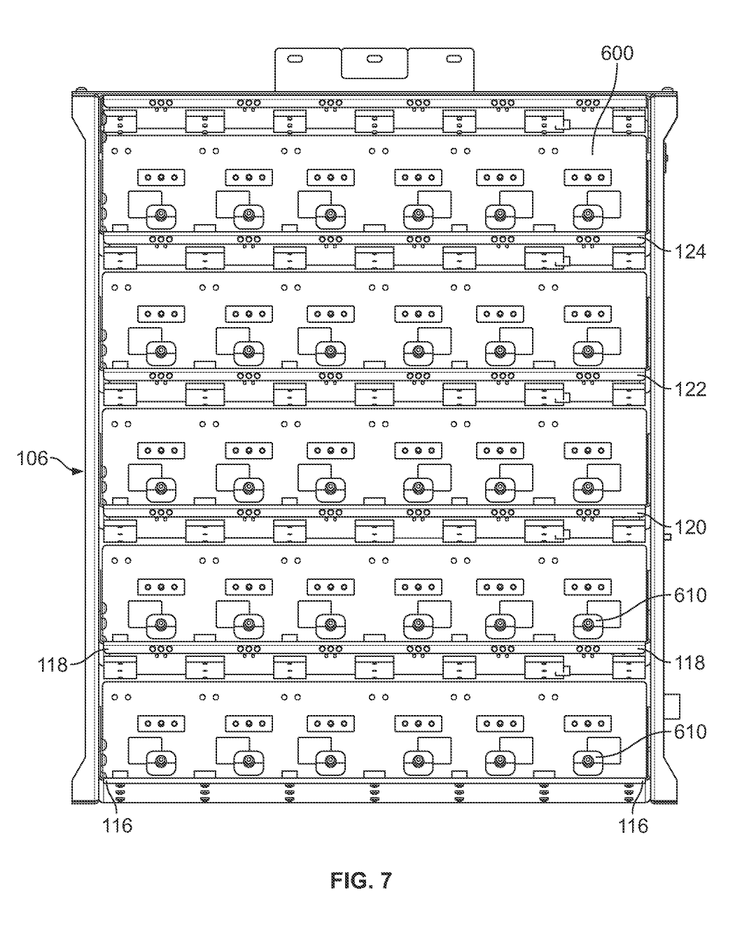

FIG. 7 is a rear view of a central ingredient rack system according to various aspects of the disclosure. As shown in FIG. 7, central ingredient system 600 comprises outlets 610, with each outlet 610 corresponding to a cartridge in central ingredient system 600. Each outlet 610 may correspond to a pump assembly 135.

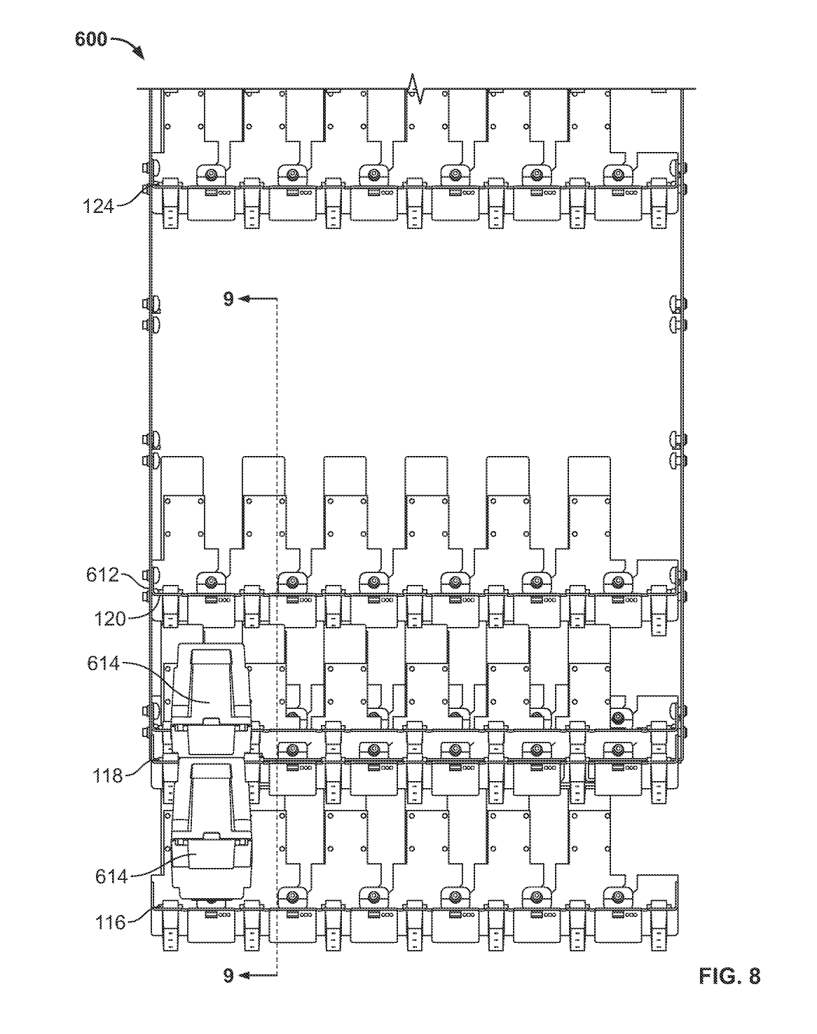

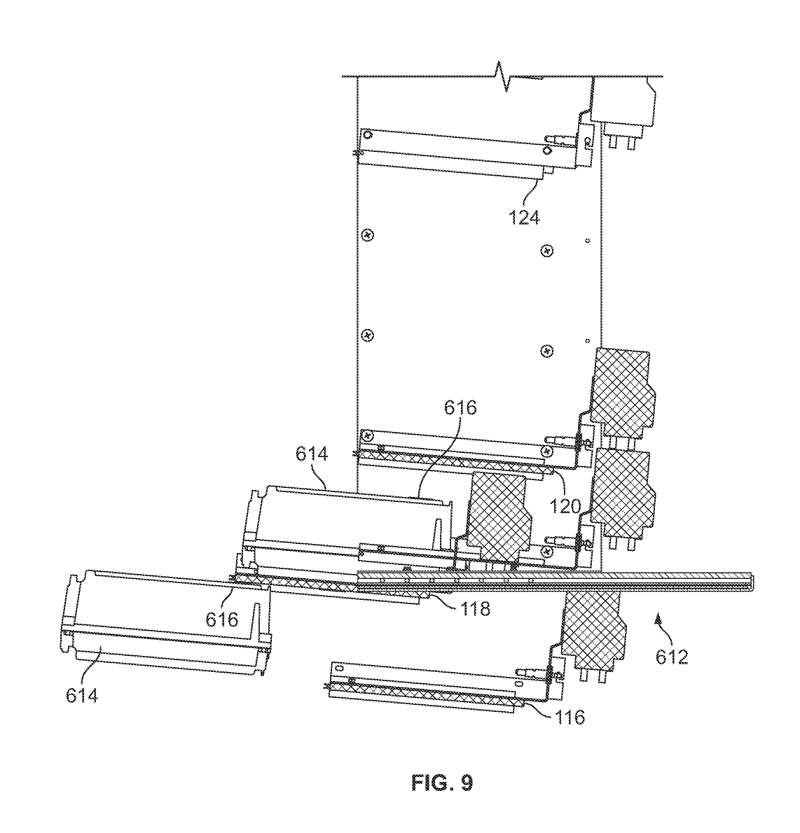

FIG. 8 is a rear view of central ingredient system 600 according to various aspects of the disclosure. As shown in FIG. 8, central ingredient system 600 comprises a rack system 612, and cartridges 614. Rack system 612 comprises shelves 116, 118, 120, 122, and 124 as shown in FIG. 2. RFID tags 616 are located on cartridges 614. Rack system 612 may comprise an RFID reader (not shown). The RFID reader may be configured to read an RFID tag 616 on a cartridge 614. As shown in FIG. 9, rack system 612 may be configured so that shelves 116, 118, 120, 122, and 124 as shown in FIG. 2, slope downwardly from the front of rack system 612 to the back of rack system 612. Thus, each cartridge 614 that is loaded onto a shelf will also slope downwardly from the front of rack system 612 to the back of rack system 612. This configuration facilitates feeding of components out of each cartridge when desired and reducing waste, i.e., reducing the amount of a component still in a cartridge when the cartridge must be replaced or replenished. In FIG. 8, shelves 116, 118, 120, and 124 are shown, but not shelf 122. FIG. 9 is a side view of the embodiment shown in FIG. 8, taken along line 9-9 in FIG. 8. FIG. 9 shows loading of a cartridge 614 and shelf 118 into rack system 612. In an embodiment, a cartridge is angled downwardly from front to back as it is loaded into rack system 612, and after the cartridge is fully loaded into rack system 612, it rests horizontal on a horizontal shelf.

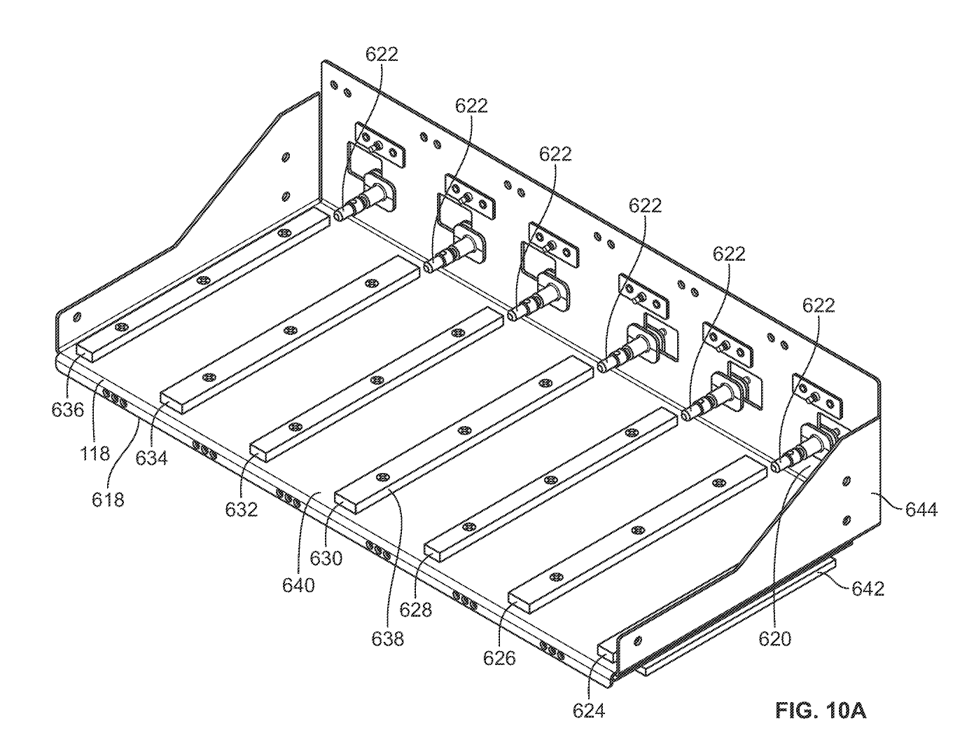

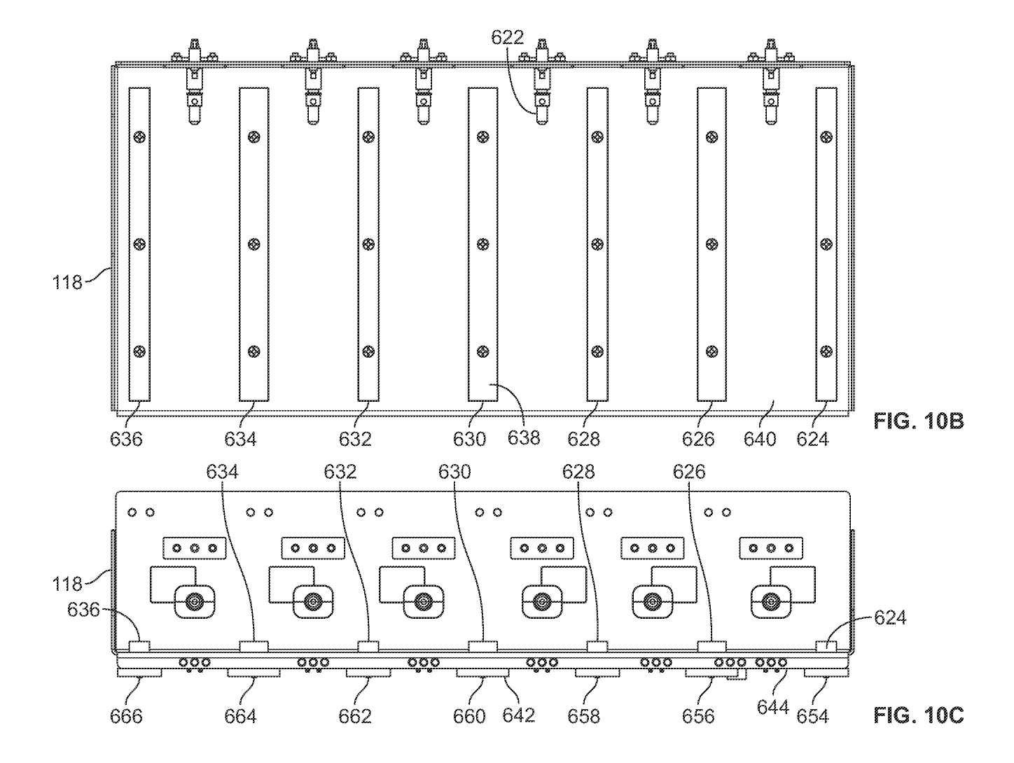

FIG. 10A is a perspective view of a rack for a central ingredient system according to various aspects of the disclosure. FIG. 10A shows a front 618 and a back 620 of a shelf of rack system 612. Rack system 612 comprises probes 622, which each probe 622 corresponding to a cartridge placed onto a shelf. Each probe 622 may be located at back 620 of a shelf of rack system 612. Rack system 612 may comprise shelves 116, 118, 120, 122, and 124 as shown in FIG. 2. FIG. 10A shows guides 624, 626, 628, 630, 632, 634, and 636 for shelf 118. Those skilled in the art will recognize that, in accordance with aspects of the disclosure, shelves 116, 120, 122, and 124 may have similar guides as for shelf 118. Guides 624, 626, 628, 630, 632, 634, and 636 may comprise guides 128 shown in FIG. 2. The guides for each shelf may be configured to receive a cartridge, e.g., cartridge 614 or a different cartridge, having predetermined dimensions. Each shelf may comprise a first set 638 of guides. First set 638 faces up from top surface 640 of a shelf. Middle shelves, for example, shelves 118, 120 and 122 shown in FIG. 2, may comprise a second set 642 of guides. Second set 642 of guides face down from bottom surface 644 of a middle shelf.

FIG. 10B is a top plan view of shelf 118 shown in FIG. 10A. As shown in FIG. 10B, guides 624, 626, 628, 630, 632, 634, and 636 may comprise guides having alternating widths. For example, guides 624, 628, 632, and 636 may have widths that are narrower than guides 626, 630, and 634.

FIG. 10C is a rear view of shelf 118 shown in FIG. 10A. As shown in FIG. 10C, second set 642 of guides may comprise guides 654, 656, 658, 660, 662, 664, and 666. Guides 654, 656, 658, 660, 662, 664, and 666 may comprise guides having alternating widths. For example, guides 654, 658, 662, and 666 may have widths that are narrower than guides 656, 660, and 664. Guides 654, 656, 658, 660, 662, 664, and 666 may be asymmetric to guides 624, 626, 628, 630, 632, 634, and 636, respectively. Those skilled in the art will recognize that, in accordance with aspects of the disclosure, first set of guides 638 and second set of guides may be configured to allow cartridges from being allowed to be placed on shelves in the correct orientation and location on shelves in the rack system.

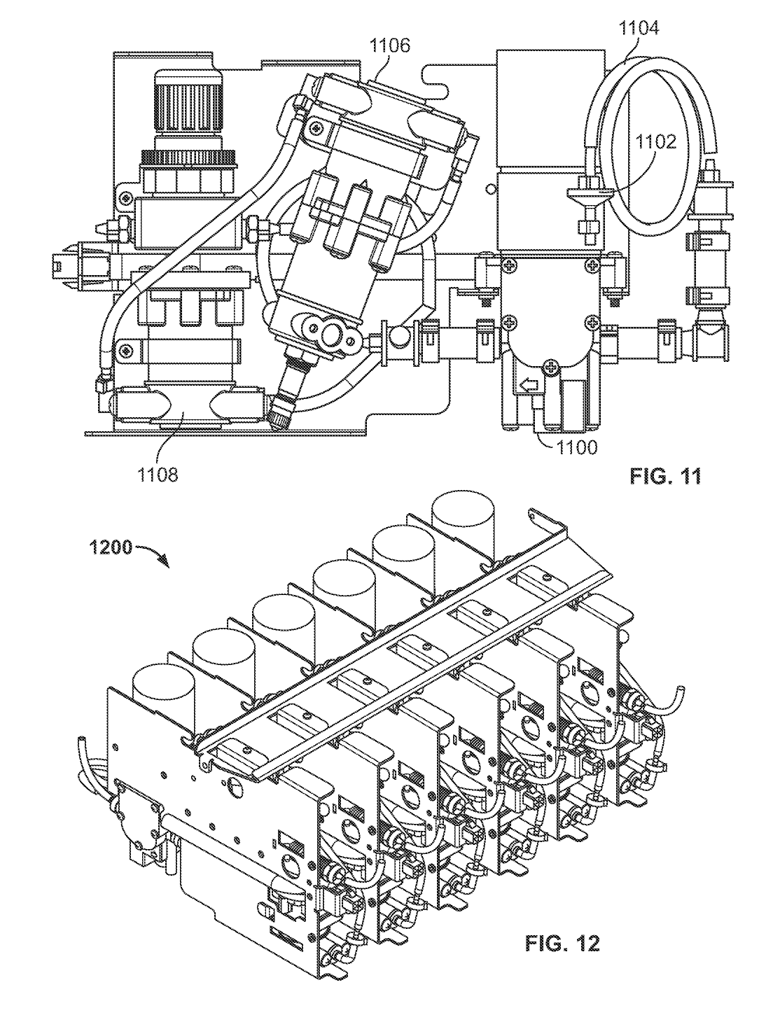

FIG. 11 is a side view of an embodiment of a pump assembly 1100 according to various aspects of the disclosure. Pump assembly 1100 comprises a valve 1102. Valve 1102 may be configured to be opened when desired to pump a component from pump assembly 1100 through tube 1104. Valve 1102 may be a check valve. Tube 1104 may be configured to transport the component to a dispensing nozzle manifold. Pump assembly 1100 may comprise an accumulator 1106 and an air vent 1108.

FIG. 12 is a perspective view of an embodiment of a six pump assembly 1200 according to various aspects of the disclosure. Each pump assembly of six pump assembly 1200 may be similar to pump assembly 1100 shown in FIG. 11.

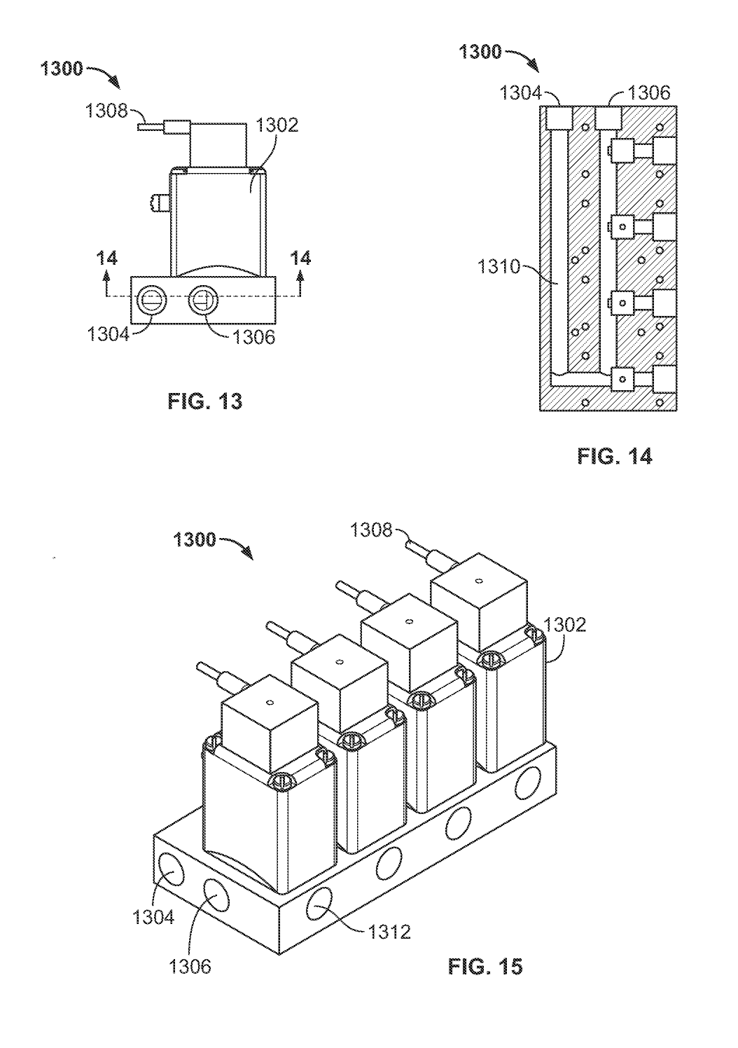

FIG. 13 is a side view of an embodiment of a pump manifold assembly 1300 according to various aspects of the disclosure. Pump manifold assembly 1300 comprises one or more valves 1302, and input opening 1304, and recirculation opening 1306. Valve 1302 may be opened or closed by sending a signal through line 1308.

FIG. 14 is a view of the embodiment shown in FIG. 13, taken along line 14-14 in FIG. 13 according to various aspects of the disclosure. Input opening 1304 may be configured to receive a component from a cartridge via a pump. The pump manifold assembly 1300 may comprise flow path 1310. Flow path 1310 may be configured to transport a component from input opening 1304 to valves 1302. Each valve 1302 may correspond to a separate, corresponding dispensing nozzle or station. Flow path 1310 may be configured to recirculate and/or remove through recirculation opening 1306 any or all of an amount of component that is not allowed to flow out of any of valves 1302. For example, such amount of component that is not alleged to flow out of any of valves 1302 may be recirculated eventually back to input opening 1304 or disposed.

FIG. 15 is a rear perspective view the embodiment shown in FIG. 13 and FIG. 14 according to various aspects of the disclosure. As shown in FIG. 15, each valve 1302 may comprise an outlet opening 1312. Each outlet opening 1312 may correspond to a separate, corresponding dispensing nozzle or station.

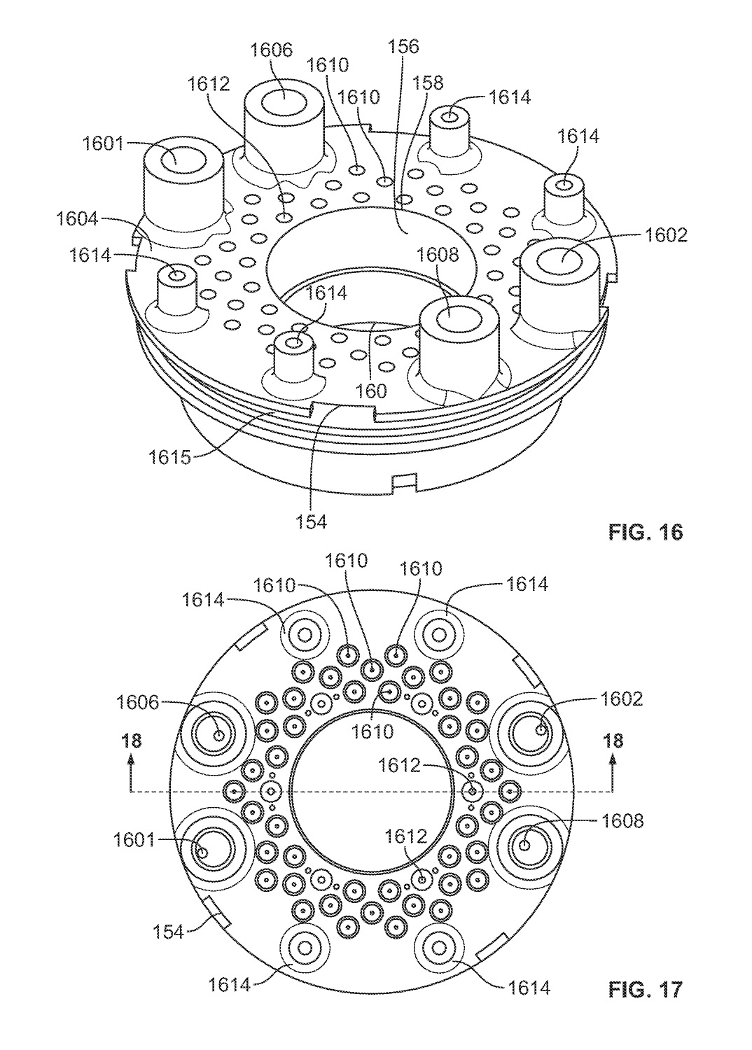

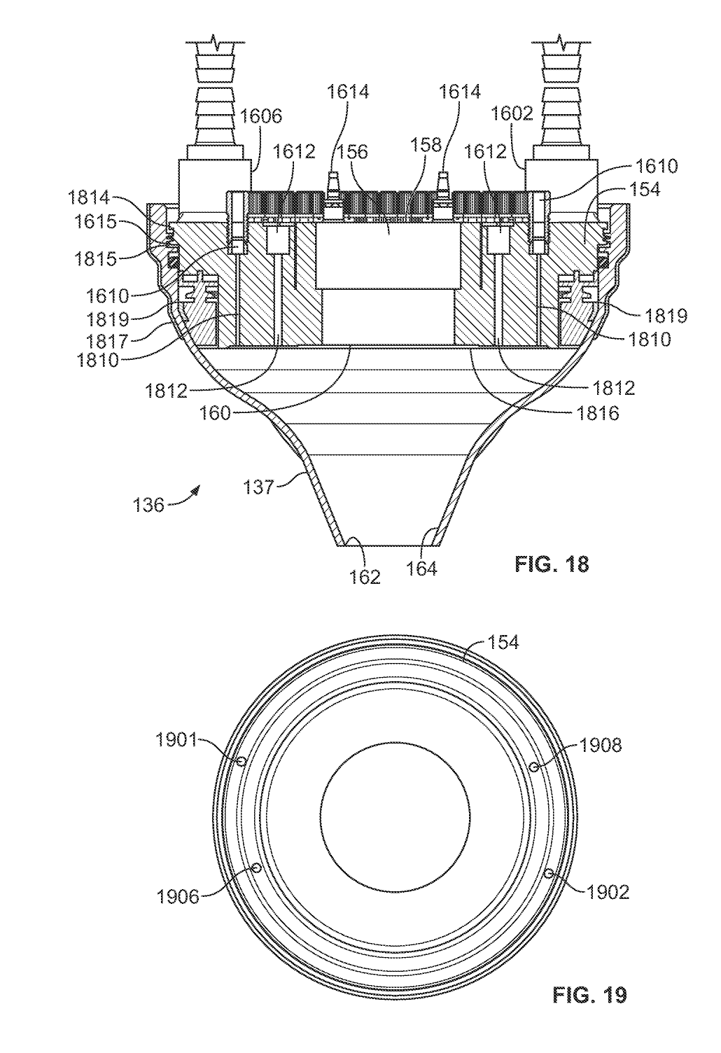

FIG. 16, FIG. 17, and FIG. 18 illustrate an embodiment according to various aspects of the disclosure. FIG. 16 is a perspective view that illustrates dispensing nozzle 136 and dispensing nozzle manifold 154 as shown in FIG. 5. Dispensing nozzle manifold 154 comprises a unitary construction bearing orifices. Each orifice may comprise a port and a corresponding conduit. Each orifice may be configured to receive a component for a free flowing food product, e.g., a beverage. As previously discussed, manifold 154 comprises a middle pathway 156. Middle pathway 156 comprises a top opening 158, and a bottom opening 160. Ports of dispensing nozzle manifold 154 comprise a first non-carbonated water port 1601 and a second non-carbonated water port 1602, with each non-carbonated water port on a top ring 1604, and opposite each other. Dispensing nozzle manifold 154 comprises a first carbonated water port 1606 and a second carbonated water port 1608, with each non-carbonated water port on top ring 1604, and opposite each other. Dispensing nozzle manifold 154 comprises forty-four small dosing ports 1610, six medium dosing ports 1612, and four sweetener ports 1614. Manifold 154 may comprise threads 1615, further discussed below.

FIG. 17 illustrates a top plan view of the embodiment shown in FIG. 16 according to various aspects of the disclosure. FIG. 18 is a cross sectional side view of the embodiment shown in FIG. 17 taken along line 18-18 in FIG. 17 according to various aspects of the disclosure. Dispensing nozzle 136 comprises dispensing nozzle manifold 154. Dispensing nozzle 136 comprises a funnel 164. Each small dosing port 1610, medium dosing port 1612, and sweetener port 1614 may have a corresponding conduit. For example, each small dosing port 1610 may have a corresponding conduit 1810. Each medium dosing port 1612 may have a corresponding conduit 1812. Each sweetener port 1614 may have a corresponding conduit (not shown in FIG. 18). The sweetener ports 1614 may be configured to receive a nutritive sweetener, e.g. HFCS, or a non-nutritive sweetener, e.g., aspartame. Each conduit extends vertically through manifold 154, from the top fitting 1814 (which may be threaded with threads 1615 (see FIG. 16) to correspond to threads 1815 of a wall 1817 of body 137) to the bottom 1816 of the manifold 154. Each port, as well as a corresponding conduit, is configured to have a uniform bore or inner diameter. A threaded portion at the top of each dosing port is configured to allow each dosing port to receive a barb type fitting. Body 137 comprises a wall 1817. Wall 1817 comprises a lip 1819. Lip 1819 is configured to support diffuser 2000, further discussed below. Alternatively, wall 1817 may taper to a diameter sufficient so that wall 1817 supports diffuser 2000.

FIG. 19 is a bottom view of manifold 154 according to various aspects of the disclosure. FIG. 19 illustrates the placement of non-carbonated water conduits 1901 and 1902 that correspond to non-carbonated water ports 1601 and 1602, respectively. FIG. 19 illustrates carbonated water conduits 1906 and 1908 that correspond to carbonated water ports 1606 and 1608, respectively. The conduits extend from each of their respective ports and vertically down and through manifold 154.

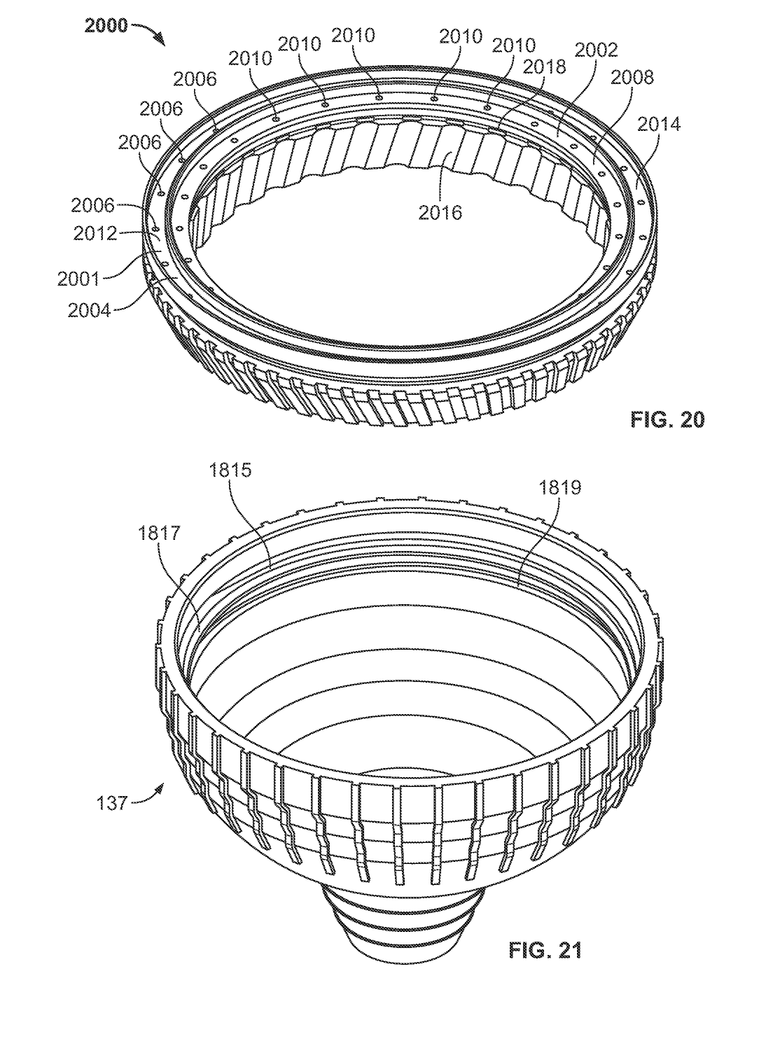

FIG. 20 is an isometric view of an embodiment according to various aspects of the disclosure. FIG. 20 illustrates a two piece water diffuser 2000. Diffuser 2000 comprises a first diffuser 2001 and a second diffuser 2002. First diffuser 2001 may comprise a first diffuser ring 2004. First diffuser 2001 may comprise first diffuser conduits 2006. First diffuser conduits 2006 may be configured to receive a first diluent (not shown). First diluent may comprise non-carbonated water.

Second diffuser 2002 may comprise a second diffuser ring 2008. Second diffuser 2002 may comprise second diffuser conduits 2010. Second diffuser conduits 2010 may be configured to receive a second diluent (not shown). Second diluent may comprise carbonated water. Ring 2008 of second diffuser 2002 may be surrounded by ring 2004 of first diffuser 2001, as shown in FIG. 20. Those skilled in the art will recognize that first diffuser 2001 may be switched with second diffuser 2002 so that ring 2004 of first diffuser 2001 is surrounded by ring 2008 of second diffuser 2002, or that non-carbonated water may be transported through second diffuser 2002, and carbonated water may be transported through first diffuser 2001.

Diffuser 2000 may be positioned below conduits extending through manifold 154 for each of the respective diluent or water ports shown in FIG. 16. As shown in FIG. 20, each of the rings 2004 and 2008 has a plurality of apertures or conduits that allow a diluent, e.g., non-carbonated water or carbonated water, to flow through the rings to facilitate a laminar flow to be produced and be transported through the dispensing nozzle 136. The flow path through the rings flows from the top trough of each of the rings through apertures, and down the channels located on the face of each of the rings. As shown in FIG. 20, ring 2004 comprises trough 2012, and ring 2008 comprises trough 2014. As shown in FIG. 20, second diffuser 2002 comprises channels 2016. Channels 2016 are configured to receive the second diluent through slots 2018. First diffuser 2001 is configured to have similar channels and slots. Channels 2016 of second diffuser 2002, and channels of first diffuser 2001, are configured to direct diluent flow downward and at an angle to produce a downward, swirling laminar flow.

FIG. 21 is perspective view of an embodiment according to various aspects of the disclosure. FIG. 21 illustrates body 137 shown in FIG. 5. Body 137 comprises threads 2100. Threads 2100 are configured to correspond to and mate with threads 1615 of manifold 154. Thus, body 137 is configured to receive and house manifold 154. Body 137 is configured to receive and house diffuser 2000, i.e., diffusers 2001 and 2002. Diffuser 2000 may be supported by body 137 at wall 1817 by lip 1819. Wall 1817 may comprise threads 1815 to correspond to and mate with threads 1615 of manifold 154.

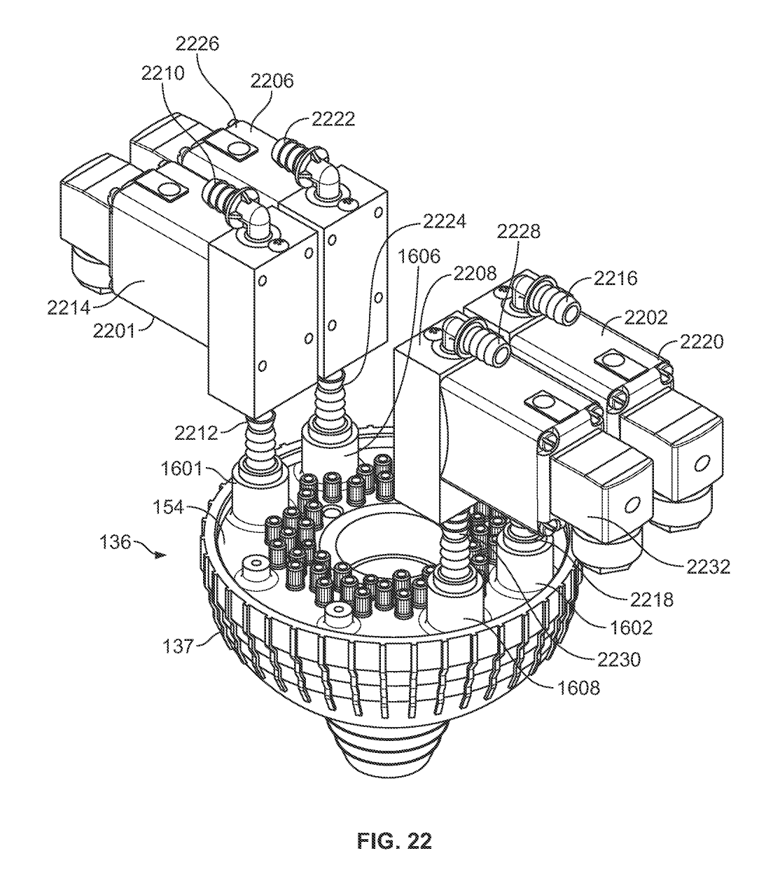

FIG. 22 is perspective view of an embodiment according to various aspects of the disclosure. FIG. 22 illustrates dispensing nozzle 136 previously discussed, and including body 137, and dispensing nozzle manifold 154. FIG. 22 also shows connection 2201 to first non-carbonated port 1601, connection 2202 to second non-carbonated port 1602, connection 2206 to first carbonated port 1606, and connection 2208 to second carbonated port 1608. Each connection may be configured to receive a diluent at a connection inlet from a source (not shown), and transport the diluent through a connection outlet to a port of the dispensing nozzle manifold 154. Connection 2201 comprises an inlet 2210, an outlet 2212, and a valve 2214. Connection 2202 comprises an inlet 2216, an outlet 2218, and a valve 2220. Connection 2206 comprises an inlet 2222, an outlet 2224, and a valve 2226. Connection 2208 comprises an inlet 2228, an outlet 2230, and a valve 2232. Valves 2214, 2220, 2226, and 2232 may be configured to be controlled by a controller (not shown) to allow a diluent to be transported from a connection inlet to a connection outlet. Those skilled in the art will recognize that, in accordance with the disclosure, dispensing nozzle manifold 154 may be configured to comprise similar connection inlets and connection outlets.

Those skilled in the art will recognize that a central ingredient system may be a source of components received by connections and transported to one or more non-diluent ports. Those skilled in the art will recognize that, in accordance with the disclosure, the source of certain components, such as a sweetener and/or an acid and/or water, and/or carbonated water, may be supplied to a connection from a source that is separate from the central ingredient system, e.g., a source in a backroom and that is not at a counter. Those skilled in the art will recognize that, in accordance with the disclosure, one or more ingredients or components, e.g., one or more macro component(s), may be supplied to a connection from a source in a backroom and that is not at a counter. Examples of macro components that may be supplied to a connection from a source in a backroom may include nutritive and non-nutritive sweeteners, one or more food grade acids, water, and carbonated water. Those skilled in the art will recognize that, in accordance with the disclosure, up to six or more macro components may be supplied to a connection from a source in a backroom. Those skilled in the art will recognize that, in accordance with the disclosure, one more components may be treated in a backroom before being supplied to a connection from a source that is separate from the central ingredient system, e.g., a source in a backroom and that is not at a counter.

Those skilled in the art will recognize that, in accordance with the disclosure, sensors may be provided in a backroom, the sensors configured to monitor one or more parameters, including but not limited to: (1) carbon dioxide tank levels (e.g., one, two or more carbon dioxide regulators); (2) carbonization head pressure of a carbonator configured to carbonate water; (3) ambient temperature of the backroom (thereby monitoring whether one or more ingredients stored in the backroom are maintained at pre-determined temperature level or within a pre-determined temperature range; (4) water filtration system parameters (e.g., water pressure, differential pressure on filters); (5) pH of water or carbonated water; (6) the date a cartridge or BIB container containing a component is loaded in backroom system; and/or (7) level of a component remaining in cartridge or BIB container loaded in a backroom system. One or more sensors may be connected to an input/output (“I/O”) rack or device, and may be configured to transmit or receive signals over a network to a smart or control system. The smart or control system may be configured to activate an alarm when a predetermined condition occurs, e.g., when the level of component in a cartridge or BIB container drops to predetermined level or when a “freshness” date or “use by” date for the component is a predetermined time from expiring. The alarm may any suitable visual and/or audible alarm. The alarm may be configured to a provide a signal that advises a user or operator to change out the cartridge or BIB container and substitute in a new cartridge or BIB that has higher level of the component or a later “freshness” date or later recommended “use by” date. The smart or control system may be configured to identify when a high volume time or period is approaching and activate an alarm to advise or warn a user or operator to change out the cartridge or BIB container and substitute in a new cartridge or BIB that has higher level of the component. The smart or control system maybe be configured to control operation of a dispenser or dispensing engine, an ingredient system (e.g., the central ingredient system discussed herein), one or more devices of an ingredient system, one or more devices of a backroom package system, and a front system/head unit (e.g., a user interface). Those skilled in the art will recognize that, in accordance with the disclosure, sensors may be provided in a backroom, the sensors configured to read a code, e.g., a bar, RFID, or alpha numeric code, on a cartridge or bag-in-box (BIB) container comprising a component. The code may correspond to a date that corresponds to a “freshness” date or a predetermined, recommended “use by” date for the component in the cartridge or BIB.

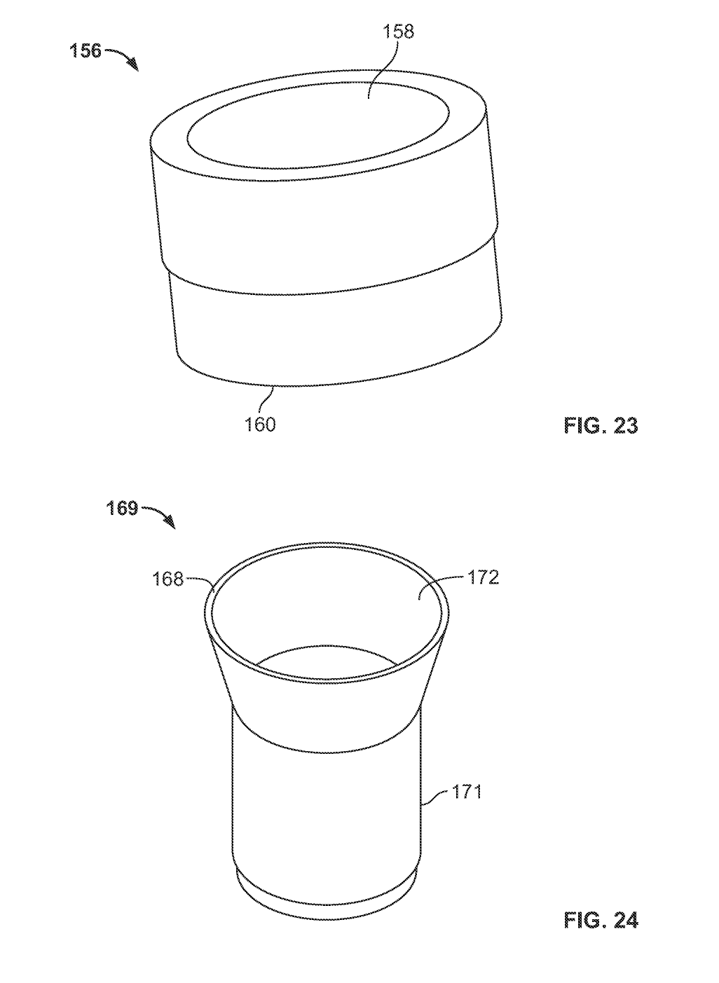

FIG. 23 is a perspective view of an embodiment according to various aspects of the disclosure. FIG. 23 shows the middle pathway 156 as illustrated in FIG. 18. Opening 158 may have a larger inner diameter than opening 160 to facilitate placement and support of the ice chute tube in an appropriate position. If the diameter of opening 158 and opening 160 were the same, then the tube may be prone to slip down into the nozzle cone.

FIG. 24 is a perspective view of an embodiment according to various aspects of the disclosure. FIG. 24 illustrates an ice chute 169 in FIG. 5. Ice chute 169 comprises a funnel 168 and a tube 171. An air gap may 172 may be defined by ice funnel 168. Air gap 172 may be configured to reduce or prevent material from going back up through the ice transport tube and into the hopper. Thus, air gap 172 may be configured to reduce or prevent contamination of the ice hopper. Air gap 172 may be configured so that if there is some splashing up of material from the dispensing nozzle manifold 154, the material will enter air gap 172, and then exit air gap 172 along the sides of ice funnel 168 and drop back down through tube 171 and the middle pathway 156, previously discussed.

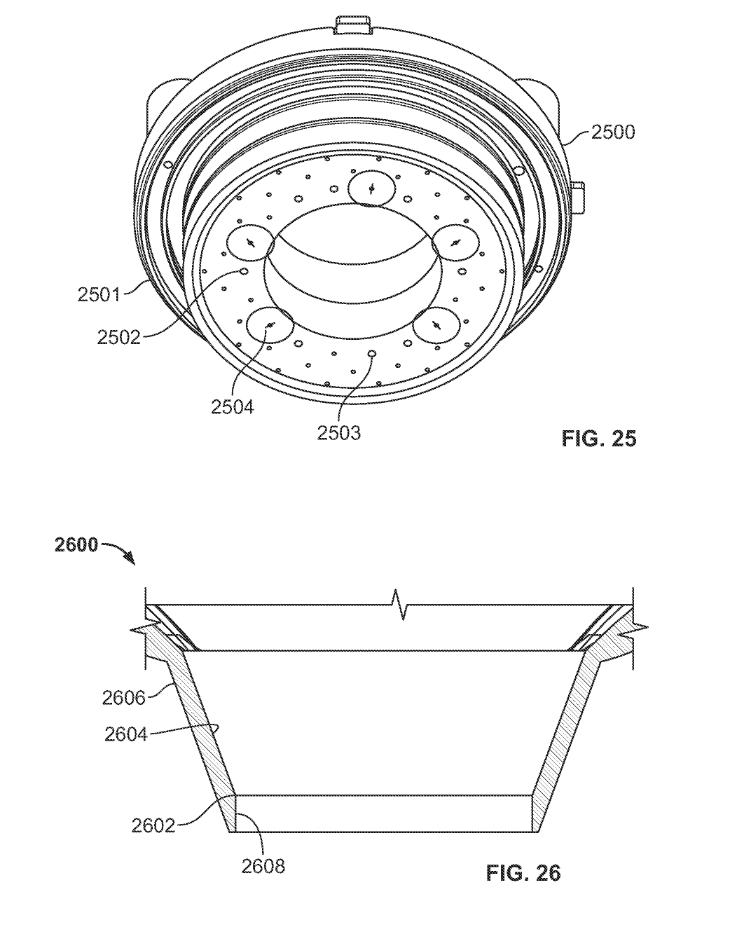

FIG. 25 is a bottom perspective view of an embodiment according to various aspects of the disclosure. FIG. 25 illustrates manifold 2500 and the placement of conduits 2501, 2502, and 2503 that correspond to the previously described small dosing ports 1610, medium dosing ports 1612, and sweetener ports 1614, respectively. Manifold 2500 may be the same as manifold 154, with the exception that manifold 2500 has splitters 2504 as discussed below. The conduits extend from each of their respective ports and vertically down and through manifold 2500. FIG. 25 illustrates that a splitter 2504 may be placed at an exit opening of any of conduits 2501, 2502, and 2503. Each splitter may be configured to split the single stream flowing through a conduit into two streams at the exit opening of the conduit. Splitting the single stream flowing through a conduit into two streams at the exit opening of the conduit may reduce the impact to the curtain of diluent (e.g., a water curtain). Splitting the single stream flowing through a conduit into two streams at the exit opening of the conduit may reduce undesirable carryover of the stream. For example, the splitter may provide structure that prevents any remaining amount of a component not used to form a first beverage from later carrying over and dropping from the conduit when forming a second beverage that may be different from the first beverage. By way of further example, the splitter may provide structure that prevents any remaining amount of a colored fruit punch component that has not dropped from the conduit and into a cup when forming a fruit punch beverage, from later dropping into a cup when forming a non-colored beverage, e.g., a lemon-lime beverage. Without the splitter, a colored fruit punch component may later drop from a conduit when forming a lemon-lime beverage, thereby resulting in undesirable color being added to the lemon-lime beverage.

Testing was performed for manifold 2500 having splitters 2504, and for manifold 154 with without splitters 2504. A first amount of a starting, non-colored water was allowed to flow through manifold 2500 with splitters 2504 and then a first funnel 164 into a first control cup, and a second amount of the starting, non-colored water was allowed to flow through manifold 154 without splitters 2504 and then a second funnel 164 into a second control cup. Each fluid in the first control cup and the second color cup was non-colored and was the control for manifold 2500 and manifold 154, respectively. Next, a first amount of a fruit punch was allowed to flow through manifold 2500 and a first funnel 164 sufficient to fill an 8 ounce cup, and a second amount of a fruit punch was allowed to flow through manifold 154 and a second funnel 164 sufficient to fill an 8 ounce cup. Next, a third amount of the starting, non-colored water was allowed to flow through manifold 2500 and the first funnel 164 and into test cup 1, and a fourth amount of the starting, non-colored water was allowed to flow through manifold 154 and the second funnel 164 and into test cup 2 (the fourth amount being equal to the third amount). It was observed by the human eye that the fluid in test cup 1 was non-colored and had the same appearance as the fluid in the first control cup. It was observed by the human eye that the fluid in test cup 2 had a color tint similar to that of the fruit punch (but with less intensity), and since it was noticeably colored, it did not have the same appearance as the fluid in the second control cup. Thus, it was observed that using manifold 2500 which had splitters 2504 provided significant improvement in reduced carryover as compared to manifold 154 that did not have splitters 2504.

FIG. 26 is a side view of an embodiment according to various aspects of the disclosure. FIG. 26 illustrates a funnel 2600. Funnel 2600 may be used in place of funnel 164 shown in FIG. 5 and FIG. 18. Funnel 2600 may have a diameter of about 1.25 inches. Funnel 2600 may comprise a break 2602 between a slanted surface 2604 of wall 2606 and vertical surface 2608. Other than break 2602 and vertical surface 2608, funnel 2600 may be identical to funnel 164 shown in FIG. 5 and FIG. 18. Break 2602 and vertical surface 2608 may reduce the amount of a fluid remaining on funnel 2600, e.g., remaining on an edge of funnel 2600, due to the surface tension of the fluid. Thus, break 2602 and vertical surface 2608 may provide structure that may reduce undesirable carryover of a first beverage dispensed from the funnel 2600 to a second beverage dispensed later from funnel 2600.

Testing was performed using funnel 2600 and funnel 164 (i.e., the same as funnel 2600 except it did not have break 2602 and vertical surface 2608). A first amount of a starting, non-colored water was allowed to flow through funnel 2600 and into a first control cup, and a second amount of the starting, non-colored water was allowed to flow through funnel 164 into a second control cup. Each fluid in the first control cup and the second color cup was non-colored and was the control for each funnel, respectively. Next, a first amount of a fruit punch was allowed to flow through funnel 2600 sufficient to fill an 8 ounce cup, and a second amount of a fruit punch was allowed to flow through funnel 164 sufficient to fill an 8 ounce cup. Next, a third amount of the starting, non-colored water was allowed to flow through funnel 2600 and into test cup 1, and a fourth amount of the starting, non-colored water was allowed to flow through funnel 164 and into test cup 2 (the fourth amount being equal to the third amount). It was observed by the human eye that the fluid in test cup 1 was non-colored and had the same appearance as the fluid in the first control cup. It was observed by the human eye that the fluid in test cup 2 had a color tint similar to that of the fruit punch (but with less intensity), and since it was noticeably colored, it did not have the same appearance as the fluid in the second control cup. Thus, it was observed that modifying funnel 164 so that it had break 2602 and vertical surface 2608 provided significant improvement in reduced carryover as compared to an unmodified funnel 164 with no break 2602 or vertical surface 2608.

Testing was performed using a first combination of manifold 2500 and funnel 2600 and a second combination of manifold 154 and funnel 164. A first amount of a starting, non-colored water was allowed to flow through manifold 2500 and funnel 2600 and into a first control cup, and a second amount of the starting, non-colored water was allowed to flow through manifold 154 and funnel 164 into a second control cup. Each fluid in the first control cup and the second color cup was non-colored and was the control for each funnel, respectively. Next, a first amount of a fruit punch was allowed to flow through manifold 2500 and funnel 2600 sufficient to fill an 8 ounce cup, and a second amount of a fruit punch was allowed to flow through manifold 154 and funnel 164 sufficient to fill an 8 ounce cup. Next, a third amount of the starting, non-colored water was allowed to flow through manifold 2500 and funnel 2600 and into test cup 1, and a fourth amount of the starting, non-colored water was allowed to flow through manifold 154 and funnel 164 and into test cup 2 (the fourth amount being equal to the third amount). It was observed by the human eye that the fluid in test cup 1 was non-colored and had the same appearance as the fluid in the first control cup. It was observed by the human eye that the fluid in test cup 2 had a color tint similar to that of the fruit punch (but with less intensity), and since it was noticeably colored, it did not have the same appearance as the fluid in the second control cup. Thus, it was observed that the combination of manifold 2500 and funnel 2600 provided significant improvement in reduced carryover as compared to manifold 154 (no splitters 2504) and funnel 164 (with no break 2602 or vertical surface 2608). Carryover Brix readings of fluid dispensed from the first combination of manifold 2500 and funnel 2600 confirmed the visual observation that the first combination results in low carryover. When the above testing was repeated five times, the first combination resulted in carryover Brix readings of 0.21, 0.30, 0.21, 0.19 and 0.17 for an average Brix reading of 0.21.

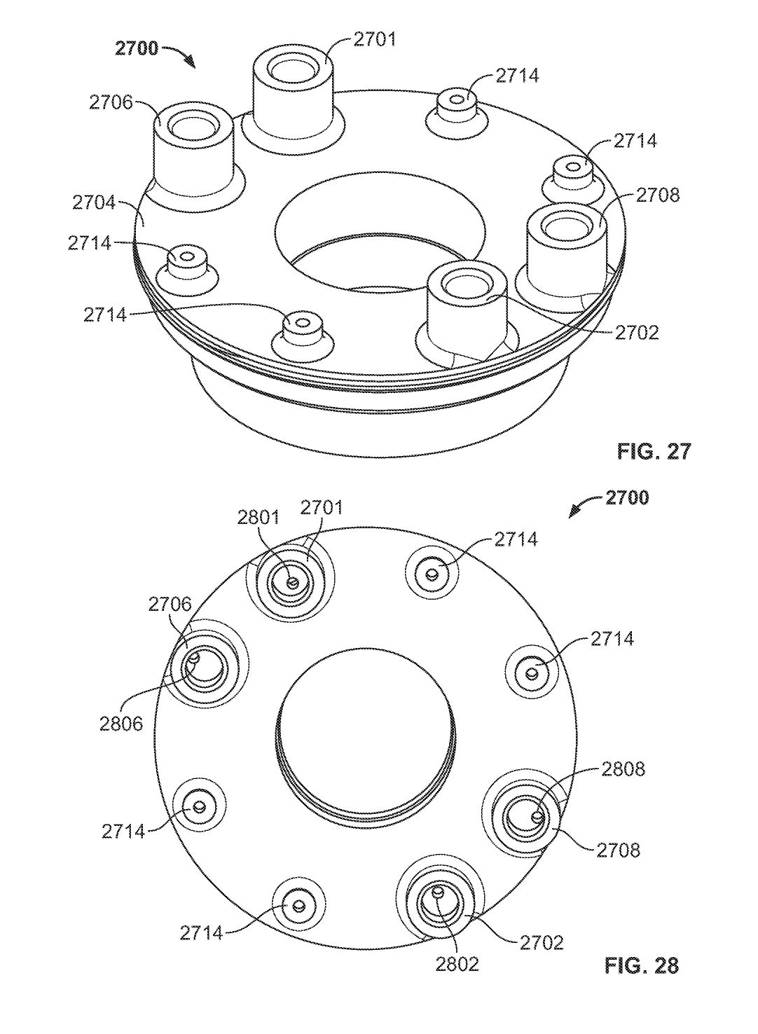

FIG. 27 is a top perspective view of nozzle manifold 2700, and FIG. 28 is a top partial view manifold 2700. Manifold 2700 may be the same as or similar to manifold 154. Ports of manifold 2700 comprise a first non-carbonated or still water port 2701 and a second non-carbonated or still water port 2702, with each non-carbonated water port on a top ring 2704, and opposite each other. Manifold 2700 comprises a first carbonated water port 2706 and a second carbonated water port 2708, with each non-carbonated water port on top ring 2704, and opposite each other. Manifold 2700 may comprise forty-four small dosing ports (not shown), six medium dosing ports (not shown), and four sweetener ports 2714, which may be similar to small dosing ports 1610, six medium dosing ports 1612, and four sweetener ports 1614 previously described with respect to manifold 154 shown in FIG. 16 and FIG. 17. Manifold 2700 may comprise threads (not shown), which may be similar to threads 1615 previously discussed.

The inner diameter of openings 2801 and 2802 for non-carbonated water ports 2701 and 2702, respectively, may be 0.125 inches. With an inner diameter of 0.125 inches for openings 2801 and 2802, a total of non-carbonated or still water can be dispensed from manifold 2700 at a rate of about 40.7166 g/s. In another embodiment, the inner diameter of openings 2801 and 2802 for non-carbonated water ports 2701 and 2702, respectively, may be less or more than 0.125 inches. For example, inner diameter of openings 2801 and 2802 for non-carbonated water ports 2701 and 2702, respectively, may be 0.130 inches. With an inner diameter of 0.130 inches for openings 2801 and 2802, a total of non-carbonated or still water may be dispensed from manifold 2700 at a rate of about 44.277 g/s.

The inner diameter of openings 2806 and 2808 for carbonated water ports 2706 and 2708, respectively, may be 0.125 inches. With an inner diameter of 0.125 inches for openings 2806 and 2808, a total of carbonated water can be dispensed from manifold 2700 at a rate of about 58.7166 g/s. In another embodiment, the inner diameter of openings 2806 and 2808 for carbonated water ports 2706 and 2708, respectively, may be less or more than 0.125 inches. For example, inner diameter of openings 2806 and 2808 for carbonated water ports 2706 and 2708, respectively, may be 0.108 inches. With an inner diameter of 0.108 inches for openings 2806 and 2808, a total of carbonated water may be dispensed from manifold 2700 at a rate of about 44.227 g/s.

By making the inner diameters of openings 2801 and 2802 for non-carbonated water greater than the inner diameters of openings 2806 and 2808 for carbonated water, non-carbonated water may be dispensed from manifold 2700 at the same rate that carbonated water may be dispensed from manifold 2700. Those skilled in the art will recognize that, in accordance with the disclosure, openings 2801, 2802, 2806 and 2808 may be centered with or off-center from the center of ports 2701, 2702, 2706, and/or 2708, respectively, and that doing so may ensure that fluid flowing through the respective ports is directed to a correct, predetermined first diffuser or second diffuser.

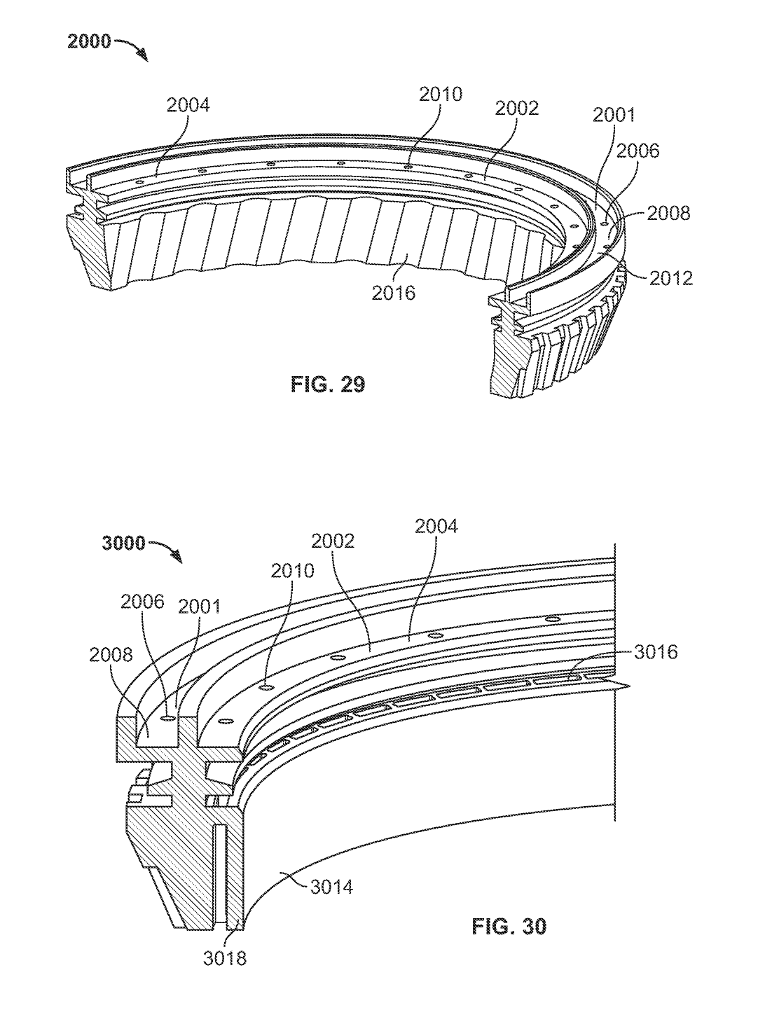

FIG, 29 illustrates a cutaway view of an embodiment according to various aspects of the disclosure. FIG. 29 illustrates diffuser 2000 as shown in FIG. 20. As previously noted, non-carbonated water may be transported through second diffuser 2002, and carbonated water may be transported through first diffuser 2001. When non-carbonated water is transported through second diffuser 2002, the non-carbonated water flows from slots 2018 shown in FIG. 20, and down at an angle through channels 2016.

FIG. 30 illustrates a cutaway view of an embodiment according to various aspects of the disclosure. FIG. 30 illustrates diffuser 3000. Diffuser 3000 may be similar to diffuser 2000. As shown in FIG. 30, diffuser 3000 may be placed inside a manifold 3014. Manifold 3014 may be similar to manifold 154 and/or manifold 2500, previously discussed. Manifold 3014 may comprise wall 3018. Wall 3018 may define channels 3016. When non-carbonated water is transported through second diffuser 2002, the non-carbonated water flows from slots 2018 shown in FIG. 20, and down at an angle through channels 3016.

FIG. 31 illustrates a perspective view of an embodiment according to various aspects of the disclosure. FIG. 31 illustrates second diffuser 2002 of diffuser 2000 as shown in FIG. 20 and FIG. 29, in combination with funnel 164 as shown in FIG. 18. As shown in FIG. 31, second diffuser 2002 may comprise inlet openings 2801 and 2802 as shown FIG. 28. Inlet openings 2801 and 2802 may each have an inner diameter of about 0.125 inches. The height of ring 3100 of second diffuser 2002 may be about 0.065 inches. Second diffuser 2002 may comprise diffuser conduits 2010 and a total of thirty (30) channels 2016. Each channel may slant downwardly at an angle of about 15.5 degrees from vertical. Body 3137 comprises an upper portion 3102, a middle portion 3104, and a lower portion 3106. Lower portion 3106 comprises funnel 164. Water exiting lower portion 3106 may be dropped into cup 3300.

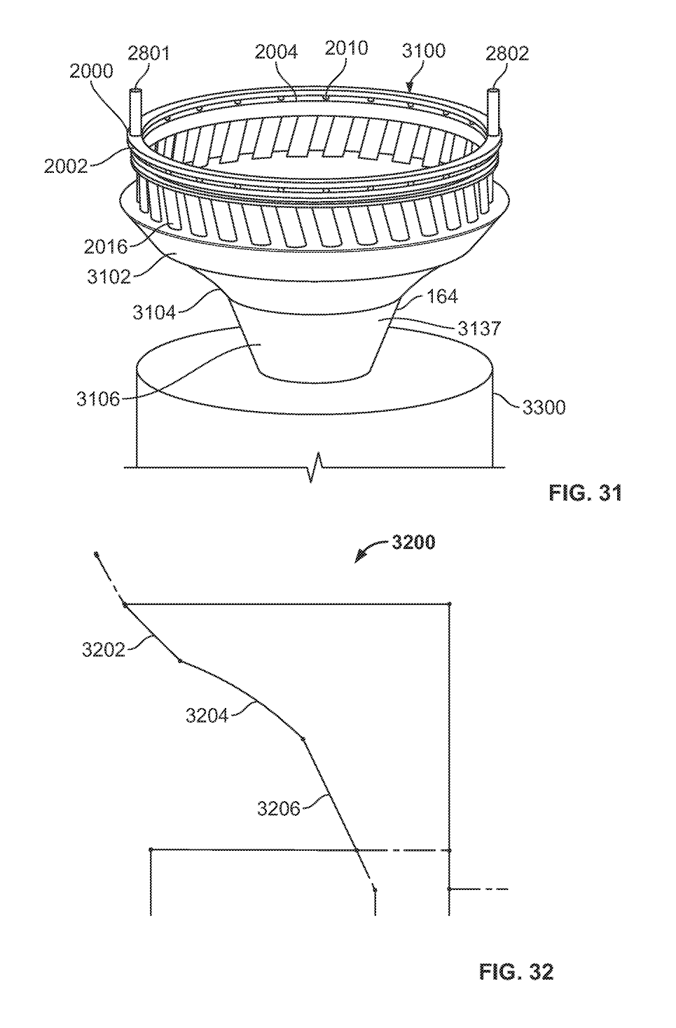

FIG. 32 illustrates a profile 3200 of the side of body 3137 shown in FIG. 31. Profile 3200 comprises an upper profile 3202, a middle profile 3204, and a lower profile 3206. Upper profile 3202 corresponds to the profile of upper portion 3102. Middle profile 3204 corresponds to the profile of middle portion 3104. Lower profile 3206 corresponds to the profile of lower portion 3106.

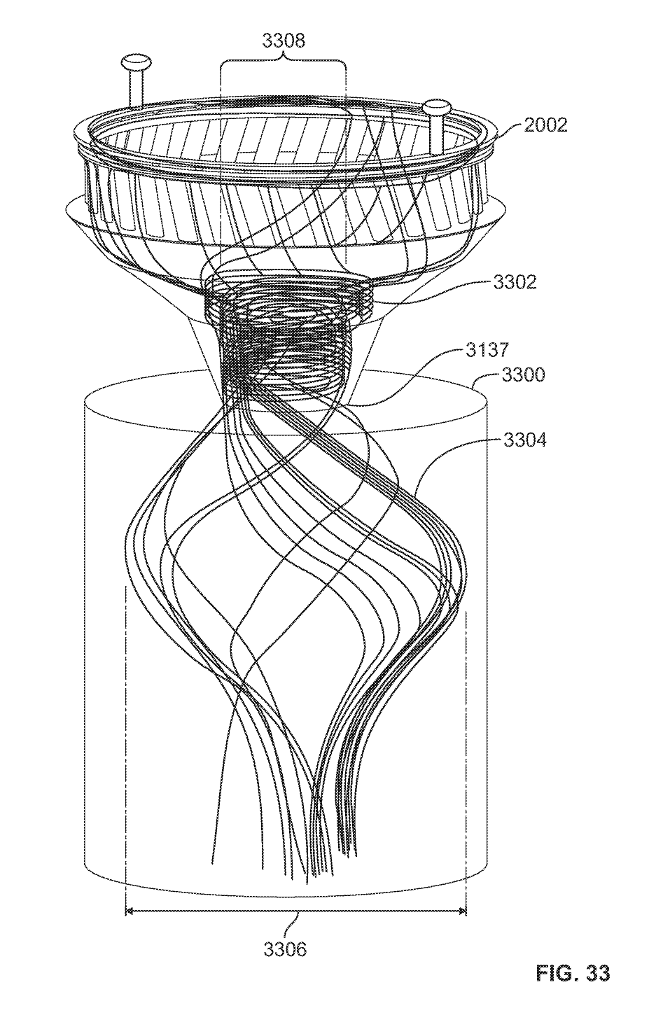

FIG. 33 illustrates flow of non-carbonated or still water 3302 through second diffuser 2002 and body 3137 and into a cup 3300. The non-carbonated water 3302 exiting body 3137 comprises a swirl 3304. Swirl 3304 has a diameter that varies as it drops into cup 3300. The greatest diameter of swirl 3304 is identified as diameter 3306, and the smallest diameter of swirl 3304 is identified as diameter 3308. The greatest diameter 3306 of swirl 3304 may be about four (4) inches.

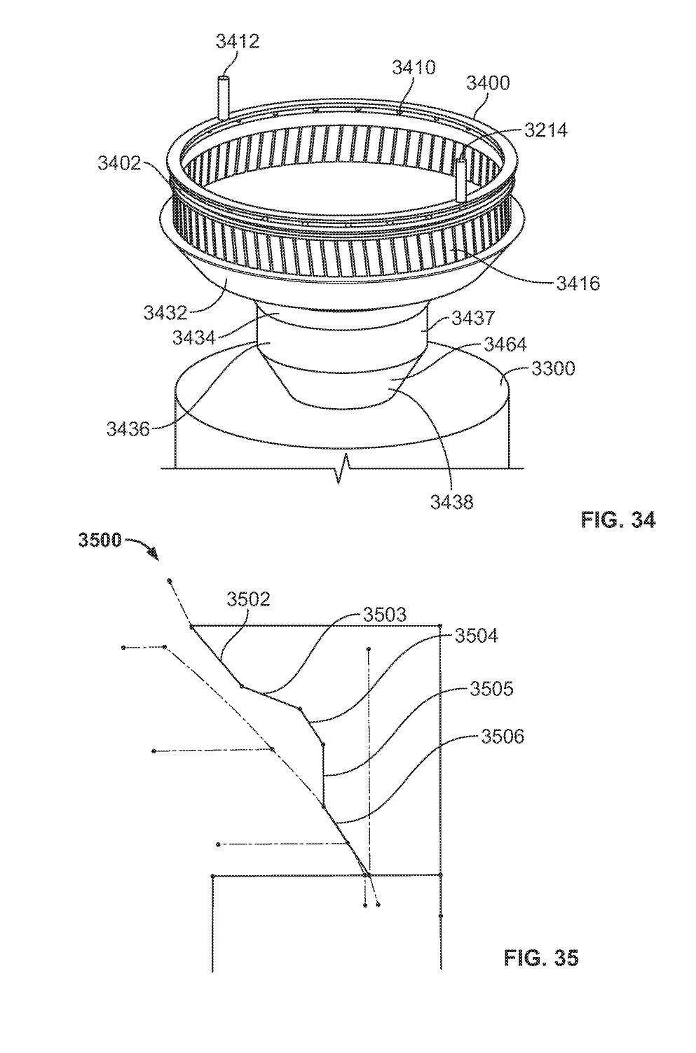

FIG. 34 illustrates a perspective view of an embodiment according to various aspects of the disclosure. FIG. 34 illustrates a diffuser 3400. Diffuser 3400 may be similar to diffuser 2000. Diffuser 3400 may comprise a second diffuser 3402, in combination with a funnel 3464. As shown in FIG. 34, second diffuser 3402 may comprise inlet openings 3412 and 3414. Inlet openings 3412 and 3414 may be similar to inlet openings 2801 and 2802 as shown FIG. 28. Inlet openings 3412 and 3214 may each have an inner diameter of about 0.130 inches. Second diffuser 3402 may comprise diffuser conduits 3410 and total of seventy-five (75) channels 3416. Each channel 3416 may slant downwardly at an angle of about 7 degrees from vertical. Body 3437 comprises an upper portion 3432, first intermediate portion 3434, second intermediate portion 3436, and lower portion 3438. Lower portion 3438 may comprise funnel 3464. Water exiting lower portion 3438 may be dropped into cup 3300.

FIG. 35 illustrates a profile 3500 of the side of body 3437 shown in FIG. 34. Profile 3500 comprises an upper profile 3502, a first intermediate profile 3503, a second intermediate profile 3504, a third intermediate profile 3505, and a lower profile 3506. Upper profile 3502 corresponds to the profile of upper portion 3432. First intermediate profile 3503 corresponds to the profile of an upper section of the first intermediate portion 3434. Second intermediate profile 3504 corresponds to the profile of a lower section of the first intermediate portion 3434. Third intermediate portion 3505 corresponds to the profile of second intermediate portion 3436, and lower profile 3506 corresponds to the profile of lower portion 3438.

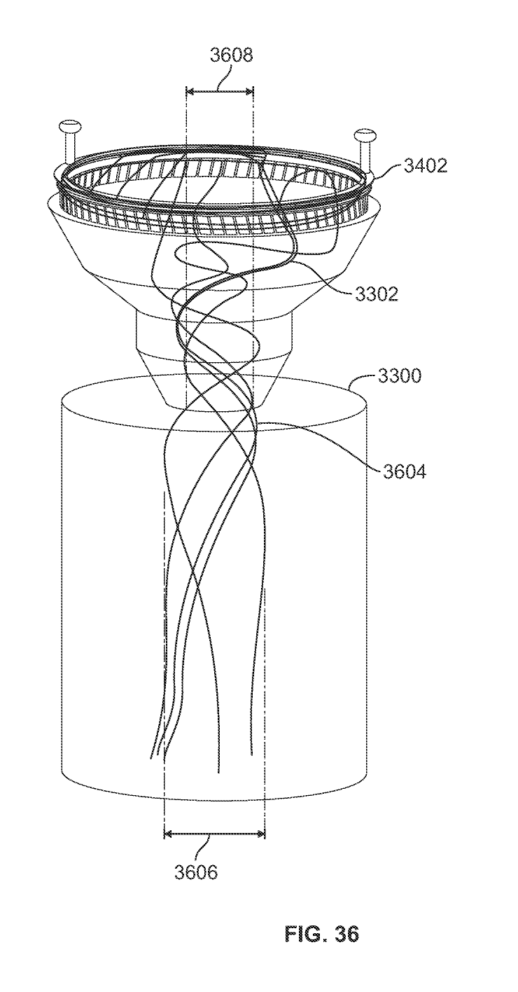

FIG. 36 illustrates flow of non-carbonated or still water 3302 through second diffuser 3402 and body 3438 and into a cup 3300. The non-carbonated water 3302 exiting body 3438 comprises a swirl 3604. Swirl 3604 has a diameter that varies as it drops into cup 3300. The greatest diameter of swirl 3604 is identified as diameter 3606, and the smallest diameter of swirl 3604 is identified as diameter 3608. The greatest diameter 3606 of swirl 3604 may be about three (3) inches.

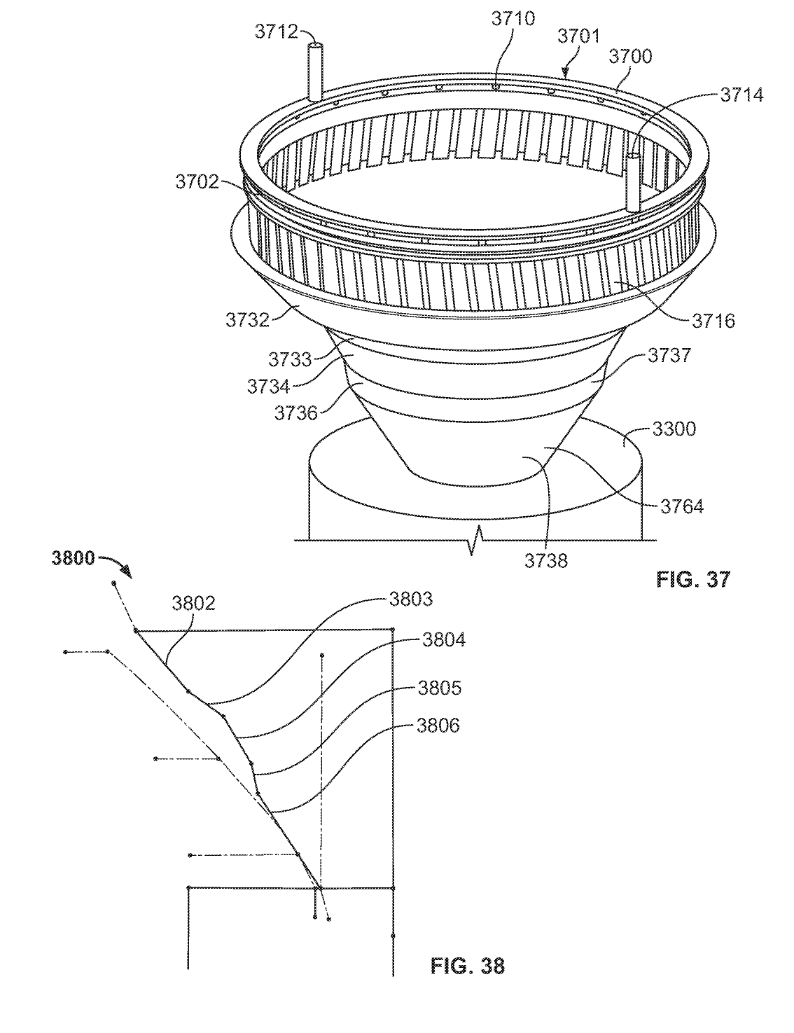

FIG. 37 illustrates a perspective view of an embodiment according to various aspects of the disclosure. FIG. 37 illustrates a diffuser 3700. Diffuser 3700 may be similar to diffuser 2000. Diffuser 3700 may comprise a second diffuser 3702, in combination with a funnel 3764. As shown in FIG. 37, second diffuser 3702 may comprise inlet openings 3712 and 3714. Inlet openings 3712 and 3714 may be similar to inlet openings 2801 and 2802 as shown FIG. 28. Inlet openings 3412 and 3214 may each have an inner diameter of about 0.130 inches. The height of ring 3701 of second diffuser 3702 may be about 0.040 inches. Second diffuser 3702 may comprise diffuser conduits 3710 and total of sixty (60) channels 3716. Each channel 3716 may slant downwardly at an angle of about 7 degrees from vertical. Body 3737 comprises an upper portion 3732, first intermediate portion 3733, second intermediate portion 3734, third intermediate portion 3736, and lower portion 3738. Lower portion 3738 may comprise funnel 3764. Water exiting lower portion 3738 may be dropped into cup 3300.

FIG. 38 illustrates a profile 3800 of the side of body 3737 shown in FIG. 37. Profile 3800 comprises an upper profile 3802, a first intermediate profile 3803, a second intermediate profile 3804, a third intermediate profile 3805, and a lower profile 3806. Upper profile 3802 corresponds to the profile of upper portion 3832. First intermediate profile 3803 corresponds to the profile of first intermediate portion 3733. Second intermediate profile 3804 corresponds to the profile the second intermediate portion 3734. Third intermediate profile 3806 corresponds to the profile of third intermediate portion 3736. Lower profile 3806 corresponds to the profile of lower portion 3738.

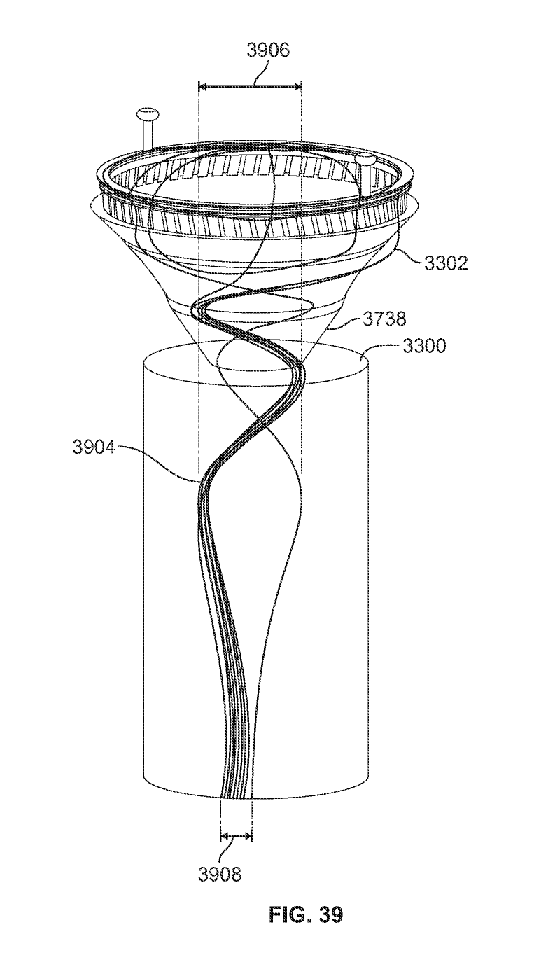

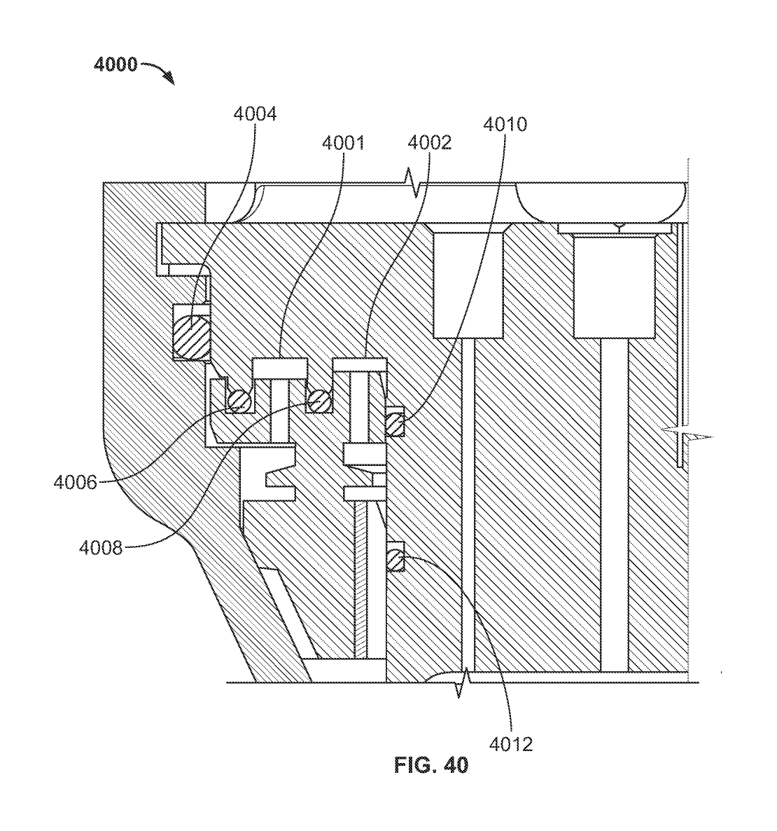

FIG. 39 illustrates flow of non-carbonated or still water 3302 through second diffuser 3702 and body 3738 and into a cup 3300. The non-carbonated water 3302 exiting body 3738 comprises a swirl 3904. Swirl 3904 has a diameter that varies as it drops into cup 3300. The greatest diameter of swirl 3904 is identified as diameter 3906, and the smallest diameter of swirl 3904 is identified as diameter 3908. The greatest diameter 3906 of swirl 3904 may be about three (3) inches.

FIG. 33, FIG. 36, and FIG. 39 show flow of non-carbonated water through the respective embodiments shown in those figures as dispensed at a 3 second steady state rate.

FIG. 40 is a cutaway view of an embodiment in accordance with aspects of the disclosure. FIG. 40 illustrates a manifold 4000 wherein non-carbonated water and/or carbonated water channels 4002 and 4004, respectively, are inside manifold 4000. Manifold 4000 comprises a funnel seal O-ring 4004 (−250) with 17.5% compression, a carbonated water channel O-ring 4006 (−48) with 25% compression, a non-carbonated water channel O-ring 4008 (−46) with 25% compression, and non-carbonated water wall O-rings 4010 and 4012 (−44) with 17.5% compression.

FIG. 41 is a top perspective view of an embodiment in accordance with aspects of the disclosure. FIG. 41 shows a manifold 4100. Manifold 4100 may be similar to manifold 154. Manifold 4100 comprises tabs 4102 extending from top ring 4104. While three tabs 4102 are shown in FIG. 41, those skilled in the art will recognize that in accordance with the disclosure, manifold 4100 may comprise one, two, three or more tabs 4102.

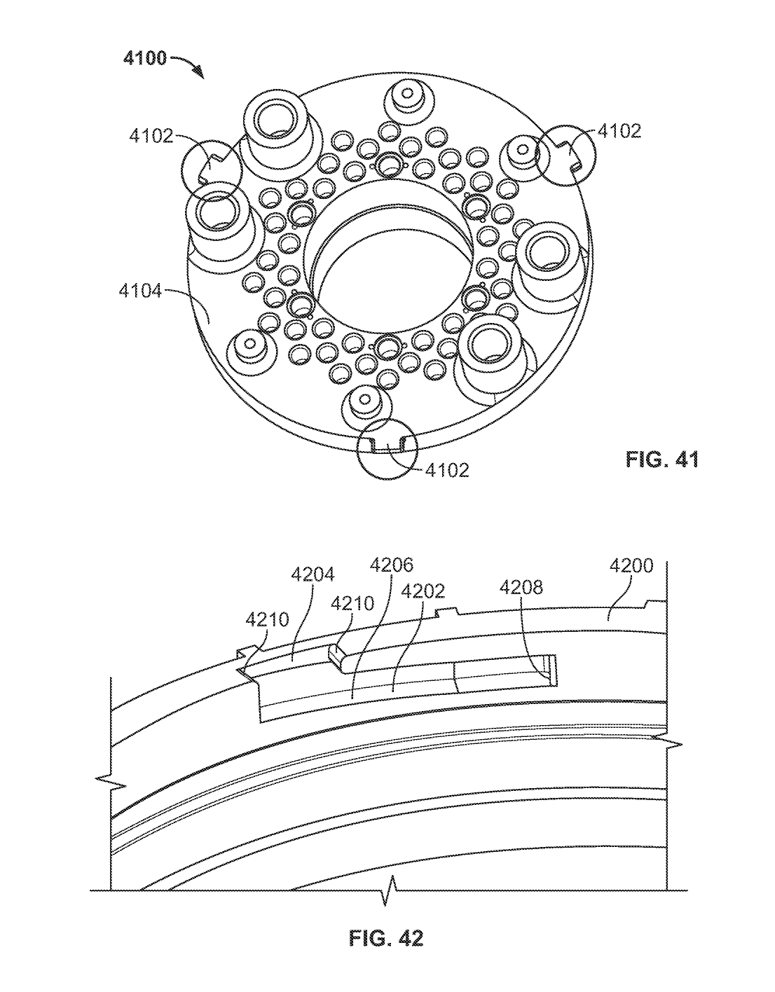

FIG. 42 is a top perspective view of a body 4200. Body 4200 may be similar to body 137, body 3137, body 3437, or body 3737, previously discussed. Body 4200 may comprise guide(s) 4202. Each guide 4202 may comprise an opening 4204, and channel 4206. Channel 4206 may extend from opening 4204 to end 4208. Each guide 4202 may be configured to receive through opening 4204 one of tabs 4102. Opening 4204 may comprise radii 4210 to provide each alignment of tab 4102 with opening 4204. Upon being received through opening 4204 and into channel 4206, manifold 4100 may be rotated in relation to body 4200 to move the received tab 4102 towards end 4208. The positive stop of end 4208 may prevent under tightening or over tightening of manifold 4100 in relation to body 4200. The amount of rotation of manifold 4100 in relation to body 4200 may be about 1/16 inches. Easy, low torque installation, with a quick turn of about 1/16 inches may be provided with this structure. The above combination of tabs 4102 of manifold 4100 with openings 4204 and guides 4202 of body 4200 provides a bayonet type design and may ensure proper alignment and locking of body 4200 onto manifold 4100. The above combination may also provide easy unlocking of body 4200 from manifold 4100 by simply rotating manifold 4100 in relation to body 4200 in the opposite direction from that used for locking so that tab 4102 is moved away from end 4208 and to opening 4204, at which point tab 4102 can be moved out through opening 4204.

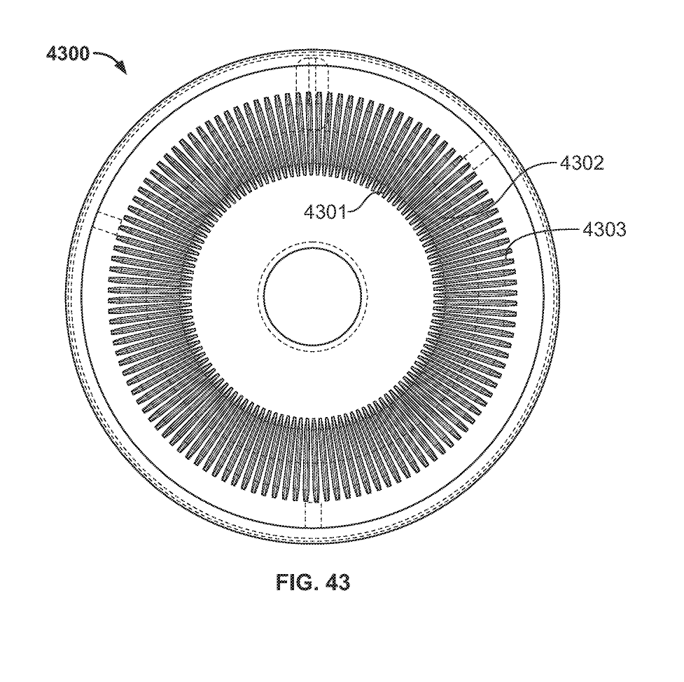

FIG. 43 is a bottom view of a light ring of a dispensing system according to various aspects of the disclosure. Light ring 4300 comprises light rings 4301, 4302, and 4303. Each light ring 4301, 4302 and 4303 may comprise a ring of light emitting diode (LED) light(s). Light ring 4300 may be placed on a surface of a funnel. Those skilled in the art will recognize that in accordance with the disclosure the LED light(s) may be configured to direct a user where to place a cup so that it is properly positioned under a dispensing nozzle, i.e., provide optical targeting. In an embodiment, the LED light(s) may comprise ultraviolet (UV) LED light(s) to reduce or retard microbiological growth, e.g., such as on surface(s) of the dispensing machine, like surface(s) of a nozzle, or an enclave or cup tray configured to receive a cup. Those skilled in the art will recognize that in accordance with the disclosure the number of light rings may total one, two, three, or more than three rings. Those skilled in the art will recognize that in accordance with the disclosure the rings may be layered light rings, wherein the light rings may be displaced from one another either vertically and/or horizontally.

A user and/or customer may login at a website and/or server and order a beverage, including a custom beverage, such as their own recipe, including the amount of carbonation for the beverage, and complete the order with a purchase of the beverage (such as authorizing the purchase with inputted or previously inputted credit card information).

A user and/or customer may build a beverage using a communication device (such as a device at a remote kiosk, table, or other location), a smart phone or tablet device, and send their beverage order to a server, which upon receipt of the order, controls apparatus and/or devices to send the appropriate types and amounts of ingredients to a dispensing head or nozzle for the ordered beverage. The user and/or customer can go to the dispensing or banner area to get the ordered beverage.

A user and/or customer, after placing a beverage order with the server, may receive back from the server a code that can be read at a beverage dispenser. The beverage dispenser, upon reading the code, can send the code to a server that controls the dispensing of beverage ingredients from a nozzle into a cup or container.

A user and/or customer may receive a cup or container that has a code, and upon reading of the code, the beverage dispenser can send the code to a server that controls the dispensing of beverage ingredients from a nozzle into a cup or container.

The system may include an application, such as a smartphone or tablet application, wherein a user and/or customer can enter beverage order information to a server.

In one aspect, there is provided a modular dispensing system comprising a plurality of cartridges, each cartridge having a highly concentrated beverage micro component having a concentration of a micro component to diluent of at least about 30:1. The modular dispensing system may comprise plurality of micro dosing devices, each micro dosing device corresponding to one of the highly concentrated beverage components, each micro dosing device configured to dose its corresponding highly concentrated beverage component at a predetermined flow rate or predetermined quantity. Upon being dosed by its corresponding micro dosing device, each highly concentrated micro component may be transported the dispensing nozzle. The micro dosing devices may be devices that are built-in or at each corresponding cartridge for each micro component.

In one aspect, pure micro-dosing is provided. In an embodiment, a concentrated beverage ingredient having a ratio by weight of beverage ingredient to water of at least 1000:1 is dosed using a micro dosing device, and is sent through a pipe at a predetermined flow rate to a dispensing nozzle and is mixed with water to form a predetermined beverage.

As will be recognized by those skilled in the art, the above described embodiments may be configured to be compatible with fountain system requirements, and can accommodate a wide variety of fountain offerings, including but not limited beverages known under any PepsiCo branded name, such as Pepsi-Cola®, and custom beverage offerings. The embodiments described herein offer speed of service at least and fast or faster than conventional systems. The embodiments described herein may be configured to be monitored, including monitored remotely, with respect to operation and supply levels. The embodiments described are compatible with for carbonated and non-carbonated beverages. The embodiments described herein are economically viable and can be constructed with off-the-shelf components, which may be modified in accordance with the disclosures herein.

Those of skill in the art will recognize that in accordance with the disclosure any of the features and/or options in one embodiment or example can be combined with any of the features and/or options of another embodiment or example.

The disclosure herein has been described and illustrated with reference to the embodiments of the figures, but it should be understood that the features of the disclosure are susceptible to modification, alteration, changes or substitution without departing significantly from the spirit of the disclosure. For example, the dimensions, number, size and shape of the various components may be altered to fit specific applications. Accordingly, the specific embodiments illustrated and described herein are for illustrative purposes only.

We claim:

1. A dispensing nozzle comprising:
a top portion, a middle portion, and a bottom portion; and
a dispensing nozzle manifold comprising a plurality of orifices, wherein each orifice comprises a corresponding port and a corresponding conduit;
the dispensing nozzle manifold comprising at least a first orifice configured to receive a first diluent, and at least a second diluent orifice configured to receive a second diluent, and at least two free-flowing food component orifices configured to receive free-flowing food components;
wherein the top portion of the dispensing nozzle comprises a plurality of ports, each port corresponding to an orifice of the plurality of orifices;
wherein the middle portion of the dispensing nozzle comprises a first set of conduits, each conduit of the first set of conduits corresponding to a port;
wherein the bottom portion of the dispensing nozzle comprises a funnel having a side wall;
the funnel configured to receive at least the first diluent and/or the second diluent, and allow the received diluent to flow downwardly and in a swirling path along the side wall of the funnel and mix with at least one free-flowing food component before the received diluent and the at least one free-flowing food component exit the dispensing nozzle.

2. The dispensing nozzle of claim 1, wherein at least one of the plurality of ports is a first non-carbonated water port configured to receive non-carbonated water.

3. The dispensing nozzle of claim 2, wherein at least one of the plurality of ports is a second non-carbonated water port configured to receive non-carbonated water, wherein the first and second non-carbonated water ports are located on a ring of the top portion of the dispensing nozzle and are on opposite each other.

4. The dispensing nozzle of claim 1, wherein at least one of the plurality of ports is a first carbonated water port configured to receive carbonated water.

5. The dispensing nozzle of claim 4, wherein at least one of the plurality of ports is a second carbonated water port configured to receive carbonated water, wherein the first and second carbonated water ports are located on a ring of the top portion of the dispensing nozzle and are on opposite each other.

6. The dispensing nozzle of claim 5, wherein at least one of the plurality of ports is a first non-carbonated water port configured to receive non-carbonated water, and at least one of the plurality of ports is a second non-carbonated water port configured to receive non-carbonated water, wherein the first and second non-carbonated water ports are located on a ring of the top portion of the dispensing nozzle and are on opposite each other.

7. The dispensing nozzle of claim 6, wherein plurality of ports further comprises dosing ports, wherein each dosing port is configured to receive a free-flowing food component, wherein the dosing ports are smaller than the first and second carbonated water ports, and smaller than the first and second non-carbonated water ports.

8. The dispensing nozzle of claim 7, wherein the plurality of ports further comprises sweetener ports, wherein each sweetener port is configured to receive a sweetener.

9. The dispensing nozzle of claim 8, wherein at least one sweetener port is configured to receive a nutritive sweetener.

10. The dispensing nozzle of claim 8, wherein at least one sweetener port is configured to receive a non-nutritive sweetener.

11. The dispensing nozzle of claim 1, further comprising:
a first diffuser having a first diffuser ring and first diffuser conduits, the first diffuser ring configured to receive the first diluent, and second diffuser ring and second diffuser conduits, the second diffuser ring configured to receive the second diluent, the second diffuser ring configured to receive the second diluent.

12. The dispenser nozzle of claim 11, wherein the first diluent comprises non-carbonated water and the second diluent comprise carbonated water.

13. The dispenser nozzle of claim 11, wherein either the first diffuser ring surrounds the second diffuser ring, or the second diffuser ring surrounds the first diffuser ring, wherein the first diluent comprises non-carbonated water and the second diluent comprise carbonated water.

14. The dispenser nozzle of claim 13, wherein the first and second diffusers are located below the conduits of the dispensing nozzle manifold.

15. The dispenser nozzle of claim 14, wherein the first diffuser ring comprises a first diffuser trough and first diffuser apertures configured to allow the first diluent to have a laminar flow path through a portion of the dispensing nozzle, wherein the second diffuser ring comprises a second diffuser trough and second diffuser apertures configured to allow the second diluent to have a laminar flow path through a portion of the dispensing nozzle.

16. The dispenser nozzle of claim 15, wherein
the first diffuser comprises first diffuser channels configured to receive the first diluent through first diffuser slots, wherein the first diffuser slots are configured to receive the first diluent from the first diffuser trough via corresponding first diffuser apertures; and
the second diffuser comprises second diffuser channels configured to receive the second diluent through second diffuser slots, wherein the second diffuser slots are configured to receive the second diluent from the second diffuser trough via corresponding second diffuser apertures.

17. The dispenser nozzle of claim 16, wherein
the first diffuser channels are configured to direct first diluent flow downward and at an angle to produce downward, swirling laminar flow of the first diluent; and
the second diffuser channels are configured to direct second diluent flow downward and at an angle to produce downward, swirling laminar flow of the second diluent.

18. The dispenser nozzle of claim 17, wherein each orifice of the dispensing nozzle manifold that corresponds to a free-flowing food component comprises an outlet having a splitter configured to split the flow of the free-flowing food component as it exits the dispensing nozzle manifold.

19. A dispensing nozzle comprising:
a top portion, a middle portion, and a bottom portion; and
a dispensing nozzle manifold comprising a plurality of orifices, wherein each orifice comprises a corresponding port and a corresponding conduit;
the dispensing nozzle manifold comprising at least a first orifice configured to receive a first diluent, and at least a second diluent orifice configured to receive a second diluent, and at least two free-flowing food component orifices configured to receive free-flowing food components;
wherein the top portion of the dispensing nozzle comprises a plurality of ports, each port corresponding to an orifice of the plurality of orifices;
wherein the middle portion of the dispensing nozzle comprises a first set of conduits, each conduit of the first set of conduits corresponding to a port;
wherein the bottom portion of the dispensing nozzle comprises a funnel having a side wall;
the funnel configured to receive at least the first diluent and/or the second diluent, and allow the received diluent to flow downwardly and in a swirling path along the side wall of the funnel and mix with at least one free-flowing food component before the received diluent and the at least one free-flowing food component exit the dispensing nozzle;
wherein the dispensing nozzle manifold comprises a middle pathway having a top opening and a bottom opening, wherein the top opening is larger than the bottom opening of the middle pathway to facilitate placement and support of an ice cube chute in an appropriate position so that the ice cube chute does not drop below the bottom opening of the middle pathway;
wherein at least one of the plurality of ports is a first non-carbonated water port configured to receive non-carbonated water;
wherein at least one of the plurality of ports is a second non-carbonated water port configured to receive non-carbonated water; and
wherein the first and second non-carbonated water ports are located on a ring of the top portion of the dispensing nozzle and are on opposite each other.

20. A dispenser comprising:
an ice cube chute; and
a dispensing nozzle, the dispensing nozzle comprising a top portion, a middle portion, and a bottom portion, and a dispensing nozzle manifold comprising a plurality of orifices, wherein each orifice comprises a corresponding port and a corresponding conduit;
the dispensing nozzle manifold comprising at least a first orifice configured to receive a first diluent, and at least a second diluent orifice configured to receive a second diluent, and at least two free-flowing food component orifices configured to receive free-flowing food components;
wherein the top portion of the dispensing nozzle comprises a plurality of ports, each port corresponding to an orifice of the plurality of orifices;
wherein the middle portion of the dispensing nozzle comprises a first set of conduits, each conduit of the first set of conduits corresponding to a port;
wherein the bottom portion of the dispensing nozzle comprises a funnel having a side wall;
the funnel configured to receive at least the first diluent and/or the second diluent, and allow the received diluent to flow downwardly and in a swirling path along the side wall of the funnel and mix with at least one free-flowing food component before the received diluent and the at least one free-flowing food component exit the dispensing nozzle;
wherein the dispensing nozzle manifold comprises a middle pathway having a top opening and a bottom opening, wherein the top opening is larger than the bottom opening of the middle pathway to facilitate placement and support of the ice cube chute in an appropriate position so that the ice cube chute does not drop below the bottom opening of the middle pathway;
wherein the ice chute comprises an ice funnel having a top opening and a bottom opening, wherein the ice funnel is configured to receive ice through the top opening and down through the bottom opening of the ice funnel;
wherein the ice tube funnel defines an air gap configured to reduce material from splashing back up through the top opening of the ice funnel.
